(19) United States
(12) Patent Application Publication
(10) Pub. No.: US 2014/0014138 A1
(43) Pub. Date: Jan. 16, 2014

(54) GAS-LIQUID PHASE TRANSITION METHOD AND APPARATUS FOR CLEANING OF SURFACES IN SEMICONDUCTOR MANUFACTURING

(71) Applicants: Jeffrey J. Spiegelman, Del Mar, CA (US); Russell J. Holmes, San Diego, CA (US); Daniel Alvarez, Oceanside, CA (US); Luigi Scaccabarozzi, Valkenswaard (NL); Sjoerd Nicolaas Lambertus Donders, Vught (NL); Henricus Jozef Castelijns, Bladel (NL)

(72) Inventors: Jeffrey J. Spiegelman, Del Mar, CA (US); Russell J. Holmes, San Diego, CA (US); Daniel Alvarez, Oceanside, CA (US); Luigi Scaccabarozzi, Valkenswaard (NL); Sjoerd Nicolaas Lambertus Donders, Vught (NL); Henricus Jozef Castelijns, Bladel (NL)

(21) Appl. No.: 13/817,088

(22) PCT Filed: Aug. 10, 2011
(86) PCT No.: PCT/US11/47299

§ 371 Date: Oct. 3, 2013

Related U.S. Application Data
(60) Provisional application No. 61/374,190, filed on Aug. 16, 2010.

(51) Int. Cl. B08B 7/00; B08B 3/04

(52) U.S. Cl. CPC B08B 7/0014; B08B 3/04
USPC 134/31; 134/105

(57) ABSTRACT

A method and apparatus for cleaning an article in semiconductor manufacturing are provided. The method includes subjecting a first chamber containing the article to a vapor source while controlling a temperature of the article and a temperature of the vapor source such that vapor from the vapor source condenses on a surface of the article to form a liquid film. The method further includes evaporating the liquid film, whereby the evaporating liquid transports contaminants from the surface of the article. Evaporating includes exposing the first chamber to condensing surfaces having a temperature lower than a temperature of the article, whereby the evaporated liquid condenses on the condensing surfaces. The apparatus includes a first chamber for housing the article, a vapor source connected to the first chamber, a temperature controller, and a second chamber connected with the first chamber to collect the vapor evaporated from the article.

### FIELD OF THE INVENTION

Methods of cleaning articles, such as a patterning device in the field of lithography, and apparatus for conducting same are provided. The article to be cleaned can be, for example, a substrate, a reticle, or other patterning device used in lithography, including extreme ultraviolet lithography.

### BACKGROUND OF THE INVENTION

Conventional aqueous wet cleaning methods in semiconductor manufacturing are facing tremendous challenges with decreasing line widths and high aspects ratio features on the order of a few nanometers. Water or other liquid surface tension is such that in many instances, the liquid may only partially penetrate nanometer sized trenches and vias now being fabricated on semiconductor wafers and other substrates. This problem is accentuated by the fact that particles sizes leading to “Killer” defects are now on the order of about 20 nm or less and are reaching the realm of molecular contamination. For instance, molecular contaminants arising from hydrocarbons or plastics can range in size from about 0.2 nm to about 10 nm. Thus, large molecular contaminants such as heavy organic molecules, metallic atom, or metal oxide clusters are similar in size to semiconductor device line widths. Wafer and other critical surface cleaning must take into account chemical affinity of the cleaning medium toward particle and molecular contaminants as well as accessibility to these contaminants which may be embedded in the minute features. Additionally, minute feature size leads to mechanically and chemically fragile structures, therefore forceful mechanical methods and highly corrosive conditions can be detrimental and should be minimized or avoided.

Wafer cleaning is the most frequently repeated step in Integrated Circuit (IC) manufacturing, and newer IC processes can typically have over 100 cleaning steps. Every wafer processing step is a potential source of contamination, which may lead to defect formation and device failures. Wafer surfaces can have different types of contaminants, including particles, organic residues, metal residues, and other inorganic residues. The purpose of wafer cleaning is to remove these contaminants without causing damage to chemically grown structures on the wafer surface.

Currently, there are two classifications of cleaning methods, wet liquid phase chemistries and dry gas phase chemistries. New devices typically contain non-planar geometries (trenches, vias, gates, porous dielectrics, etc.) that are difficult to clean. Liquid surface tension hinders the accessibility with wet methods, and device features are ultra-thin and minute in size. These are easily damaged by traditional aggressive gases (HF, HCl, Cl₂) used in dry processes. Beyond silicon, other materials (Ge, SiGe, SiC, GaN, GaAs, InP, InSb, ZnO, InSnO3, sapphire) can have additional chemical complexity where cleaning chemistries are not fully developed, and traditional methods, such as, megasonic cleaning methods, can cause damage. To address these issues, several cleaning technologies are under development, including Atomized liquid jet Spray; HF vapor cleaning; cryogenic aerosol cleaning; supercritical fluid cleaning; and pinpoint laser cleaning; however, these methods can exhibit certain drawbacks as discussed above for wet liquid phase and dry gas phase methods.

Lithography is widely recognized as one of the key steps in the manufacture of integrated circuits (ICs) and other devices and/or structures. Shrinking dimensions of features to be made using lithography have placed harsh demands on the technology for enabling miniature IC or other devices and/or structures to be manufactured. In photolithography, phase shifting and double patterning techniques have nearly zero tolerance for the presence of particle contamination. Traditionally, transparent pellicle films have been used to prevent particle contamination. New Extreme Ultraviolet (EUV) techniques may use a photomask without the pellicle, however.

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Current lithography systems project mask pattern features that are extremely small. Dust or extraneous particulate matter appearing on the surface of the reticle can adversely affect the resulting product. Any particulate matter that deposits on the reticle before or during a lithographic process is likely to distort features in the pattern being projected onto a substrate. Therefore, the smaller the feature size, the smaller the size of particles critical to eliminate from the reticle.

A pellicle is often used with a reticle. A pellicle is a thin transparent layer that may be stretched over a frame above the surface of a reticle. Pellicles are used to block particles from reaching the patterned side of a reticle surface. Although particles on the pellicle surface are out of the focal plane and should not form an image on the wafer being exposed, it is still preferable to keep the pellicle surfaces as particle-free as possible.

A theoretical estimate of the limits of pattern printing can be given by the Rayleigh criterion for resolution as shown in equation (1):

$$CD = {k}_{1} * \frac{λ}{{NA}_{PS}} \qquad ( 1 )$$

where λ is the wavelength of the radiation used, NA_{PS} is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NAPS or by decreasing the value of k₁.

In order to shorten the exposure wavelength and, thus, reduce the minimum printable size, it has been proposed to use an extreme ultraviolet (EUV) radiation source. EUV radiation sources are typically configured to output a radiation wavelengths of around 5-20 nm, for example, 13.5 nm or about 13 nm. Thus, EUV radiation sources may constitute a significant step toward achieving small features printing. Such radiation is termed extreme ultraviolet or soft x-ray, and possible sources include, for example, laser-produced plasma sources, discharge plasma sources, or synchrotron radiation from electron storage rings.

For EUV lithography processes, however, pellicles are not used, because they would attenuate the imaging radiation. When reticles are not covered, they are prone to particle contamination, which may cause defects in a lithographic process. Particles on EUV reticles are one of the main sources of imaging defects. An EUV reticle (or other reticle for which no pellicle is employed) is likely to be subjected to organic and inorganic particle contamination. Particle sizes as small as around 20 nm could lead to fatal defects on the wafer and to zero yield.

Inspection and cleaning of an EUV reticle before moving the reticle to an exposure position can be an important aspect of a reticle handling process. Reticles are typically cleaned when contamination is detected. Typical methods of cleaning a reticle may include megasonic cleaning, carbon dioxide snow cleaning and laser shockwave cleaning. However, these techniques of cleaning a reticle may shorten the reticle lifetime as they may bring damage to the reticle, or may be not suitable for use in a vacuum environment, or may be undesirable for cleaning particles of 20 nm or less in size. For example, any need to remove the reticle from the vacuum environment in which it is used will seriously reduce the throughput achievable in production.

### SUMMARY OF THE INVENTION

New Extreme Ultraviolet (EUV) techniques may use a photomask without a pellicle; therefore there is a need for cleaning techniques that ensure that the photomask remains particle free. There is also a need for a method of removing particles and molecular contamination from semiconductor wafers and other substrates, semiconductor films, as well as critical surfaces associated with semiconductor manufacturing.

The cleaning methods of preferred embodiments utilize delivery of high purity steam or other low vapor pressure chemistries (typically, at sub-atmospheric pressures) to one or more critical surfaces having contaminants thereon under conditions of controlled temperature and pressure so as to induce condensation of the vapor on the critical surface. Steam and other low vapor chemistries may thus be delivered into high aspect ratio features contained within semiconductor wafers or other critical surfaces to be cleaned. As a result of vapor phase delivery and subsequent condensation, small contaminant particles situated on such critical surfaces may come into direct contact with liquid droplets. In a subsequent step, pressure and temperature conditions are manipulated in a manner that induces rapid evaporation or removal of the water or liquid droplets. These droplets and/or water vapor may entrain and remove contaminant particles as well as molecular contamination from critical surfaces. In effect, the vapor phase delivery allows for accessibility to the nano-sized particles and molecular contaminants. Condensation can occur on contaminant particles and can deposit localized energy onto the particle surface. In addition, the high purity water is ion deficient. The combination of deposited thermal heat from condensation and ultrapure solvent that is starved for ions makes an aggressive cleaning agent. The rapid re-vaporization process enables highly localized energy transfer and consequent dislodging of the particle or molecular contaminant. The method may include the presence of a carrier gas and/or chemically reactive gases or solvents to assist in particulate or molecular contaminate removal that may have partially dissolved in the condensate. The method may be repeated several times in a cyclic fashion in order to allow for complete removal of contaminant particles from critical surfaces. In a further embodiment, the wafer or critical surface may be held under carrier gas purge for extended time periods of up to about 48 hours to ensure dryness subsequent to performing the cleaning method.

Accordingly, in a first aspect, a method of cleaning an article is provided, comprising: placing an article in a cleaning chamber, wherein contaminants are present on a surface of the article; evacuating the cleaning chamber; connecting the cleaning chamber to a vapor source while controlling a temperature of the article and a temperature of the vapor source relative to one another such that vapor from the vapor source condenses on the article to form a liquid film; isolating the cleaning chamber from the vapor source; and evaporating the liquid film, whereby the evaporating liquid transports at least a portion of the contaminants away from the surface of the article.

In an embodiment of the first aspect, the liquid film is evaporated by exposing the cleaning chamber to one or more condensing surfaces having a temperature lower than a temperature of the article, whereby the evaporated liquid condenses on the condensing surfaces.

In an embodiment of the first aspect, the one or more condensing surfaces is a wall of a condensing chamber separate from the cleaning chamber, and wherein the evaporating comprises opening a valve between the cleaning chamber and the condensing chamber.

In an embodiment of the first aspect, the surface of the article is held at a temperature of from about −20° C. to about 120° C. during the condensing of the evaporated liquid.

In an embodiment of the first aspect, the liquid film is evaporated by exposing the cleaning chamber to a lower pressure, whereby the evaporated liquid is removed from the cleaning chamber.

In an embodiment of the first aspect, the vapor source is a reservoir of a liquid controlled to have a temperature higher than that of the article.

In an embodiment of the first aspect, walls of the cleaning chamber are controlled to a temperature above that of the vapor source so as to prevent condensation of the vapor on the walls of the cleaning chamber.

In an embodiment of the first aspect, the method further comprises controlling a pressure of the cleaning chamber by a vacuum pump connected to the cleaning chamber, wherein the vacuum pump is isolated from the cleaning chamber prior to the evaporating.

In an embodiment of the first aspect, the steps of placing, evacuating, connecting, isolating and evaporating are repeated one or more times to remove at each time at least a portion of remaining contaminant particles.

In an embodiment of the first aspect, the cleaning chamber further comprises an electrostatic structure for attracting contaminant particles in the evaporated liquid film.

In an embodiment of the first aspect, the contaminants include contaminant particles.

In an embodiment of the first aspect, the contaminants include molecular contaminants.

In an embodiment of the first aspect, the vapor is steam.

In an embodiment of the first aspect, the article is selected from the group consisting of a semiconductor film, a semiconductor wafer, an apparatus employed in manufacturing a semiconductor device, a semiconductor film, a completed silicon device, a GaN film, a light emitting diode or component thereof, a silicon containing wafer, a CdTe containing wafer, a CuInGaSe containing wafer, a photovoltaic device or component thereof, a semiconductor sensor or component thereof, and an optical device or component thereof.

In an embodiment of the first aspect, the article is a semiconductor film of a flat panel displays.

In an embodiment of the first aspect, the article is a photolithography patterning device, a photolithography mask, a photolithography optical assembly, or a photolithography reticle.

In an embodiment of the first aspect, the article is a deep or extreme ultraviolet lithography patterning device, a deep or extreme ultraviolet lithography mask, a deep or extreme ultraviolet lithography optical assembly, or a deep or extreme ultraviolet lithography reticle.

In an embodiment of the first aspect, the evaporating is conducted under sub-atmospheric conditions.

In an embodiment of the first aspect, the vapor is provided in a carrier gas.

In an embodiment of the first aspect, the vapor is provided in a carrier gas selected from the group consisting of hydrogen, oxygen, nitrogen, helium, argon, ozone, carbon dioxide, carbon monoxide, air, and mixtures thereof.

In an embodiment of the first aspect, the vapor is delivered at a temperature of from about −50° C. to about 200° C., e.g., from about −20° C. to about 120° C., or from about 0° C. to about 120° C., or from about 0° C. to about 100° C.

In an embodiment of the first aspect, the vapor is delivered at a pressure of from about 0.01 torr to about 5000 torr, e.g., from about 0.1 torr to about 2000 torr or from about 1 torr to about 760 torr.

In an embodiment of the first aspect, the vapor is steam delivered at a temperature of from about −50° C. to about 200° C., e.g., from about −20° C. to about 120° C., or from about 0° C. to about 120° C., or from about 0° C. to about 100° C.

In an embodiment of the first aspect, the vapor is steam delivered at a pressure of about 0.01 torr to about 5000 torr, e.g., from about 0.1 torr to about 2000 torr or from about 1 torr to about 760 torr.

In an embodiment of the first aspect, the evaporation is conducted at a temperature of from about −50° C. to about 200° C., e.g., from about −20° C. to about 120° C., or from about 0° C. to about 120° C., or from about 0° C. to about 100° C.

In an embodiment of the first aspect, the evaporation is conducted at a pressure of from about 0.01 torr to about 5000 torr, e.g., from about 0.1 torr to about 2000 torr or from about 1 torr to about 760 torr.

In an embodiment of the first aspect, the surface of the article is held at a temperature of from about −50° C. to about 200° C., e.g., from about −20° C. to about 120° C., or from about 0° C. to about 120° C., or from about 0° C. to about 100° C.

In an embodiment of the first aspect, the method further comprises, after evaporating, drying the surface of the article at an elevated temperature.

In an embodiment of the first aspect, the method further comprises, after evaporating, drying the surface of the article under a carrier gas purge.

In an embodiment of the first aspect, the surface of the article is a surface of a vacuum chamber or a surface of an atmospheric deposition chamber.

In an embodiment of the first aspect, the surface of the article is a standard mechanical interface, a front-opening unified pod, or a robotic device configured to contact semiconductor materials during a manufacturing process.

In an embodiment of the first aspect, the contaminants include particles of from about 1 micron to 5 microns in size and comprising at least one of metallic contaminants, polymeric contaminants, or organic contaminants.

In an embodiment of the first aspect, the contaminants include particles less than about 1 micron in size and comprising at least one of metallic contaminants, polymeric contaminants, or organic contaminants.

In an embodiment of the first aspect, the contaminants include particles less than about 500 nm in size and comprising at least one of metallic contaminants, polymeric contaminants, or organic contaminants.

In an embodiment of the first aspect, the contaminants include particles less than about 100 nm in size and comprising at least one of metallic contaminants, polymeric contaminants, or organic contaminants.

In an embodiment of the first aspect, the contaminants include particles less than about 20 nm in size and comprising at least one of metallic contaminants, polymeric contaminants, or organic contaminants.

In an embodiment of the first aspect, the contaminants include particles less than about 1 nm in size and comprising at least one of metallic contaminants, polymeric contaminants, or organic contaminants.

In an embodiment of the first aspect, the contaminants include molecular contaminants less than about 1 nm in size.

In an embodiment of the first aspect, the vapor comprises a mixture containing water vapor or high purity steam.

In an embodiment of the first aspect, the vapor comprises one or more alcohols selected from the group consisting of methanol, ethanol, and isopropanol, and organic molecules with one or more alcohol functional groups.

In an embodiment of the first aspect, the vapor comprises one or more organic molecules with one or more alcohol functional groups.

In an embodiment of the first aspect, the vapor comprises one or more members of the group consisting of ammonia, primary amines, and secondary amines.

In an embodiment of the first aspect, the vapor comprises one or more members of the group consisting of aqueous organic acids and aqueous inorganic acids.

In an embodiment of the first aspect, the vapor comprises one or more organic solvents.

In an embodiment of the first aspect, the vapor comprises one or more organic solvents selected from the group consisting of chloroform, methylene chloride, hexane, toluene, diethylether, tetrahydrofuran, acetone, methylethylketone, acetonitrile, N-methylpyrrolidone, ethyl acetate, butyl acetate, and fluorinated hydrocarbons.

In an embodiment of the first aspect, the surface of the article comprises a sacrificial area configured to concentrate contaminants, e.g., nanoparticle or molecular contaminants, for subsequent removal.

In an embodiment of the first aspect, contaminants in the evaporated liquid are adsorbed on a concentrator comprising an adsorbent material.

In an embodiment of the first aspect, contaminants, e.g., nanoparticle or molecular contaminants, in the evaporated liquid are adsorbed on a concentrator comprising a thin film of hydrophobic or hydrophilic adsorbents.

In an embodiment of the first aspect, contaminants, e.g., nanoparticle or molecular contaminants, in the evaporated liquid are adsorbed on a concentrator comprising a high surface area porous material or a thin film adhesive.

In an embodiment of the first aspect, an area configured for concentration of contaminants, e.g., nanoparticle or molecular contaminants, for subsequent removal is provided adjacent to or in a vicinity of the surface of the article.

In an embodiment of the first aspect, the vapor source is a high purity steam generation device.

In an embodiment of the first aspect, the evaporating is performed in a presence of a carrier gas.

In a second aspect, an apparatus for cleaning an article is provided, comprising a cleaning chamber configured for housing an article having contaminants on a surface of the article; a vapor source configured to connect to the cleaning chamber via a first valve, and configured to provide a condensed liquid vapor on the surface the article in the cleaning chamber; a vacuum pump configured to connect to the cleaning chamber via a second valve, and configured to evacuate the cleaning chamber; and a chamber configured to connect with the cleaning chamber via a third valve, and configured to collect vapor evaporated from the article so as to transport contaminants away from the surface of the article.

In an embodiment of the second aspect, the chamber is a condensing chamber configured to condense a liquid film evaporated from the article, wherein the condensing chamber is configured to have a temperature lower than that of the article.

In an embodiment of the second aspect, the condensing chamber is a wall of a chamber separate from the cleaning chamber.

In an embodiment of the second aspect, the vapor is water vapor, and wherein the vapor source is configured to deliver water vapor to the condensing chamber at a sub-atmospheric pressure and at a controlled rate of from about 18 micrograms per minute to about 3 kilograms per minute.

In an embodiment of the second aspect, the apparatus further comprises a second vacuum pump connected to the condensing chamber.

In an embodiment of the second aspect, the vacuum pump connected to the cleaning chamber is configured to provide a reduced pressure in the cleaning chamber, whereby the liquid film evaporated from the article is removed from the cleaning chamber.

In an embodiment of the second aspect, the vapor source comprises a reservoir configured to maintain a liquid at a temperature higher than that of the article.

In an embodiment of the second aspect, walls of the cleaning chamber are configured to be controlled to a temperature above that of the vapor source so as to prevent condensation of the vapor on walls of the cleaning chamber.

In an embodiment of the second aspect, the apparatus further comprises a pressure regulator connecting the vacuum pump to the cleaning chamber.

In an embodiment of the second aspect, the apparatus comprises an electrostatic structure inside the cleaning chamber for attracting contaminant particles in the evaporated liquid film.

In an embodiment of the second aspect, the apparatus further comprises at least one heater and at least one temperature controller configured to control a temperature of at least of one of the chamber walls, the surface of the article, the vapor, a reservoir, or a carrier gas.

In an embodiment of the second aspect, the apparatus further comprises an area configured to concentrate contaminants for subsequent removal, wherein the area is adjacent to or in the vicinity of the surface of the article.

In an embodiment of the second aspect, the area configured to concentrate contaminants comprises an adsorbent configured for nanoparticle or molecular contaminant adsorption.

In an embodiment of the second aspect, the vapor source comprises a high purity steam generator.

In an embodiment of the second aspect, the apparatus further comprises an inlet port and an outlet ports configured for delivery of a carrier gas.

In an embodiment of the second aspect, the liquid film is configured to be evaporated from the article so as to transport at least 1% of the contaminants present on the surface away from the surface of the article.

In an embodiment of the second aspect, the liquid film is configured to be evaporated from the article so as to transport at least 10% of the contaminants present on the surface away from the surface of the article.

In an embodiment of the second aspect, the liquid film is configured to be evaporated from the article so as to transport at least 50% of the contaminants present on the surface away from the surface of the article.

In an embodiment of the second aspect, the liquid film is configured to be evaporated from the article so as to transport at least 90% of the contaminants present on the surface away from the surface of the article.

In an embodiment of the second aspect, the vacuum pump is configured for use without a cold trap.

In a third aspect, a system is provided comprising a lithographic apparatus for transferring a pattern from a patterning device to a succession of substrates, the system further comprising an apparatus according to the second aspect.

In an embodiment of the third aspect, the system further comprises a transferring module configured to transfer the patterning device between the apparatus and a support structure for supporting the patterning device.

In a fourth aspect, a method of manufacturing a device is provided wherein a patterning device is used to apply a device pattern to a device substrate in a lithographic process, and wherein the patterning device is cleaned one or more times by a method according to the first aspect.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention. Embodiments of the invention are described, by way of example only, with reference to the accompanying drawings.

FIG. 1 depicts schematically a lithographic apparatus having reflective projection optics.

FIG. 2 is a more detailed view of the apparatus of FIG. 1.

FIG. 3 is a more detailed view of an alternative source collector module SO for the apparatus of FIG. 1 and FIG. 2.

FIG. 4 depicts an EUV reticle with contaminant particles.

FIG. 5A is an exemplary apparatus for cleaning an article according to a preferred embodiment.

FIG. 5B is an exemplary apparatus for cleaning an article according to a preferred embodiment.

FIG. 6 is an exemplary condensing chamber which may be used in as the apparatus shown in FIG. 5A.

FIG. 7 is an exemplary method for cleaning an article according to a preferred embodiment.

FIG. 8 illustrates an exemplary effect of the evaporation of a liquid film over an article.

FIG. 9 illustrates an exemplary lithographic system including a cleaning apparatus.

FIG. 10 shows the main process steps of an inspection regime applied to clean reticles in a EUV lithography process according to a preferred embodiment.

FIG. 11 illustrates a wafer cleaning manifold of a preferred embodiment.

FIG. 12 illustrates a cross-section of a notched wafer post for holding the wafer depicted in FIG. 11 in place.

FIG. 13 is a schematic depiction of a surface of a wafer subject to cleaning with the positions of five areas identified.

FIG. 14 is a micrograph of Area 1 of the wafer depicted schematically in FIG. 13 after attachment of fluorescent polystyrene latex particles and before cleaning.

FIG. 15 is a micrograph of Area 1 of the wafer depicted schematically in FIG. 13 after attachment of fluorescent polystyrene latex particles and subsequent cleaning according to a method of a preferred embodiment.

FIG. 16 is a micrograph of Area 2 of the wafer depicted schematically in FIG. 13 after attachment of fluorescent polystyrene latex particles and before cleaning.

FIG. 17 is a micrograph of Area 2 of the wafer depicted schematically in FIG. 13 after attachment of fluorescent polystyrene latex particles and subsequent cleaning according to a method of a preferred embodiment.

FIG. 18 is a micrograph of Area 3 of the wafer depicted schematically in FIG. 13 after attachment of fluorescent polystyrene latex particles and before cleaning.

FIG. 19 is a micrograph of Area 3 of the wafer depicted schematically in FIG. 13 after attachment of fluorescent polystyrene latex particles and subsequent cleaning according to a method of a preferred embodiment.

FIG. 20 is a micrograph of Area 4 of the wafer depicted schematically in FIG. 13 after attachment of fluorescent polystyrene latex particles and before cleaning.

FIG. 21 is a micrograph of Area 4 of the wafer depicted schematically in FIG. 13 after attachment of fluorescent polystyrene latex particles and subsequent cleaning according to a method of a preferred embodiment.

FIG. 22 is a micrograph of Area 5 of the wafer depicted schematically in FIG. 13 after attachment of fluorescent polystyrene latex particles and before cleaning.

FIG. 23 is a micrograph of Area 5 of the wafer depicted schematically in FIG. 13 after attachment of fluorescent polystyrene latex particles and subsequent cleaning according to a method of a preferred embodiment.

FIG. 24 is a micrograph of Area 1 of the wafer depicted schematically in FIG. 13 after cleaning in the Cleaning Chamber at 45° C.

FIG. 25 is a micrograph of Area 2 of the wafer depicted schematically in FIG. 13 after cleaning in the Cleaning Chamber at 45° C.

FIG. 26 is a micrograph of Area 3 of the wafer depicted schematically in FIG. 13 after cleaning in the Cleaning Chamber at 45° C.

FIG. 27 is a micrograph of Area 4 of the wafer depicted schematically in FIG. 13 after cleaning in the Cleaning Chamber at 45° C.

FIG. 28 is a micrograph of Area 5 of the wafer depicted schematically in FIG. 13 after cleaning in the Cleaning Chamber at 45° C.

FIG. 29 is a micrograph of water droplet atop a wafer removed from the cleaning chamber.

FIG. 30 is an overexposed micrograph of water droplet atop a wafer removed from the cleaning chamber.

The features and advantages of the preferred embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE PREFERRED EMBODIMENT

Methods, systems and apparatus for the removal of particulate and molecular contamination from semiconductor wafers and other critical surfaces, e.g., patterning devices in the field of lithography, are provided. Certain aspects are described in relationship to semiconductor wafer cleaning or photolithography, with the understanding that such aspects may be useful in the cleaning of other critical surfaces associated with semiconductor, photovoltaic, electronic lighting, flat panel display, optical sensor, and electronics manufacturing.

Envisioned applications include, for example, cleaning processes for semiconductor wafers post photo-resist ashing, post CMP, post etch as well as cleaning throughout other semiconductor manufacturing operations. The term “critical surface” is intended to be inclusive of any surface where the presence of particulate or molecular contamination has detrimental effects to the existing or planned use of that surface. Critical surface cleaning comprises the cleaning of equipment associated with semiconductor, photovoltaic, electronic lighting, flat panel display, optical sensor, and electronics manufacturing. Examples include but are not limited to, photo-masks used in photolithography, vacuum or atmospheric deposition chambers, load-locks used in semiconductor manufacturing tools, vessels such as standard mechanical interfaces (SMIFs) and front-opening unified pods (FOUPs) used for semiconductor storage and transport, and robotic handling equipment which comes in contact with semiconductor materials during the manufacturing process. Further examples of semiconductors and critical surfaces include, but are not limited to, completed silicon devices, GaN and other compound semiconductor films, wafers and devices intended for light emitting diodes, silicon, CdTe and CuInGaSe containing wafers or films intended for photovoltaic devices, semiconductor sensors and optical devices intended for other advanced applications, and semiconductor films intended for flat panel displays.

Certain preferred embodiments are directed to methods for removing particle contaminants from semiconductor wafers and critical surfaces, where particles are in the size range of about 1 nm to about 500 nm, e.g., about 200 nm. These particles may be composed of metallic, organic, inorganic, or polymeric species. These species may or may not be soluble in the water vapor, liquid water, gaseous chemistries, or liquid chemistries disclosed by this method. In cases where the molecular contaminant in not soluble in the water or chemistry streams, they may be dislodged from the wafer or critical surface by this stream. While the methods of preferred embodiments are advantageous for the removal of particles that are most detrimental to the critical dimensions of current semiconductor devices, larger as well as smaller particles may also be removed by the described methods.

In a method of a preferred embodiment, high purity steam or other low vapor pressure chemistries in the temperature range of about 20° C. to about 120° C. are delivered to a chamber at sub-atmospheric pressures. Sub-atmospheric pressures typically range from about 1 mtorr or less to less than about 760 torr. Within the chamber, a semiconductor wafer or other critical surface is fixed in place such that the principal plane to be cleaned faces upwards, downwards, or vertical. The principal plane may include either the front side or the back side of the wafer substrate. Delivery of high purity steam or other low vapor pressure chemistries is sustained until pressure and temperature conditions inside the chamber are sufficiently altered to induce condensation of steam or other chemistries onto the wafer or critical surface. Temperature range for condensation may be from about −20° C. or less to about 100° C. or more while pressure can range from about 1 torr or less to about 760 torr or more. Electronic cooling of the critical surface may be accomplished by use of a Peltier device. Chamber temperature may also be altered by external sources such as heating or cooling devices. In addition, the wafer or critical surface may be held at a lesser temperature than the chamber to enhance condensation onto the wafer or critical surface. This temperature may be in the range of about −20° C. or less to about 100° C. or more. The vapor streams may come into contact with the principal plane to be cleaned from a horizontal direction (0 degrees), a perpendicular direction (90 degrees), or some angle x, where 0°≦x≦90°.

An apparatus suitable for delivery of purified steam includes that described in PCT Publ. No. WO 2007/058698-A1, the contents of which are hereby incorporated by reference in their entirety. The term “steam” as used herein is a broad term, and is to be given its ordinary and customary meaning to a person of ordinary skill in the art (and is not to be limited to a special or customized meaning), and refers without limitation to a gaseous mixture comprising saturated water vapor. The term “steam feed” as used herein is a broad term, and is to be given its ordinary and customary meaning to a person of ordinary skill in the art (and is not to be limited to a special or customized meaning), and refers without limitation to a steam having at least one impurity, e.g., any solid, liquid, or gas other than water vapor. Exemplary impurities include, but are not limited to, aerosols, particles, and gases other than water vapor (e.g., hydrogen, nitrogen, oxygen, carbon monoxide, carbon dioxide, hydrogen sulfide, hydrocarbons, and other volatile organic compounds), biological materials including mold, mold spores, viruses, prions, macromolecules, bacteria, metals, and ionic materials. One of ordinary skill in the art can readily appreciate that the amount of impurities can be relative and acceptable impurity levels can be determined by the ultimate application for the steam. The term “purified steam” as used herein is a broad term, and is to be given its ordinary and customary meaning to a person of ordinary skill in the art (and is not to be limited to a special or customized meaning), and refers without limitation to steam having a purity (i.e., a percent water content) greater than that of the steam feed. The purified steam can be superheated to prevent condensation or saturation. The term “high purity steam” as used herein is a broad term, and is to be given its ordinary and customary meaning to a person of ordinary skill in the art (and is not to be limited to a special or customized meaning), and refers without limitation to steam having a purity (i.e., a percent water content) of at least about 99.99999% by weight (100 ppb), e.g., a purity of at least 99.999999% by weight (10 ppb), a purity of at least 99.9999999% by weight (1 ppb), or a purity of at least 99.99999999% by weight (1 ppt). The apparatus for generating the high purity steam comprises a source of steam feed; a first passageway for directing the source of steam feed to a surface a substantially gas-impermeable ion exchange membrane; and a second passageway for directing purified steam away from an opposing surface of the substantially gas-impermeable membrane. In operation, a steam feed is passed through the substantially gas-impermeable ion exchange membrane at an operating temperature and an operating pressure to form a purified steam having a greater purity than the steam feed by removal of a contaminant, wherein the steam feed is saturated at the operating temperature and the operating pressure.

The membrane of the high purity steam generator is substantially gas-impermeable, such that it has a low leak rate of gases other than water vapor (e.g., a leak rate of less than about 10⁻³ cm³/cm²/s under standard atmosphere and pressure, i.e., conditions at sea level), or, alternatively, a ratio of the permeability of water vapor compared to the permeability of other gases of at least about 10,000:1. The membrane is an ion exchange membrane. The term “ion exchange membrane” as used herein is a broad term, and is to be given its ordinary and customary meaning to a person of ordinary skill in the art (and is not to be limited to a special or customized meaning), and refers without limitation to a membrane comprising chemical groups capable of combining with ions or exchanging ions between the membrane and an external substance. Such chemical groups include, but are not limited to, sulfonic acid, carboxylic acid, phosphoric acid, phosphoric acid, arsenic groups, selenic groups, phenols, and salts thereof. In one embodiment, the ion exchange membrane is a resin, such as a polymer containing exchangeable ions. Preferably, the ion exchange membrane is a fluorine-containing polymer, e.g., polyvinylidenefluoride, polytetrafluoroethylene (PTFE), ethylene tetrafluoride-propylene hexafluoride copolymers (FEP), ethylene tetrafluoride-perfluoroalkoxyethylene copolymers (PFE), polychlorotrifluoroethylene (PCTFE), ethylene tetrafluorideethylene copolymers (ETFE), polyvinylidene fluoride, polyvinyl fluoride, vinylidene fluoride-trifluorinated ethylene chloride copolymers, vinylidene fluoride-propylene hexafluoride copolymers, vinylidene fluoridepropylene hexafluoride-ethylene tetrafluoride terpolymers, ethylene tetrafluoride-propylene rubber, and fluorinated thermoplastic elastomers. The steam feed is provided to the membrane at a suitable temperature, e.g., from about 80° C. to about 200° C., and at a suitable pressure, e.g., a pressure of greater than 1 atm. The purified steam can be delivered into the cleaning chamber at a suitable pressure, e.g., 0.001-760 Torr. Preferably the steam is delivered to the cleaning chamber in the absence of noncondensable gases. In certain embodiments, a noncondensable gas, e.g., a purge gas, may be present. Condensable gases and vapors other than water may be present, but are preferably absent when the vapor is water vapor.

In certain embodiments, it may be advantageous to have more than one vapor stream, where additional streams may be oriented at the same, or at different angles. Initial exposure of the wafer or critical surface to the vapor stream is for a time period ranging from about 1 or less to about 300 seconds or more. Particles and molecular contaminants situated on the wafer or critical surfaces may come into contact with condensed water or liquid chemistry. This step is followed by immediate reduction of pressure and/or simultaneous increase in temperature to evaporate the liquid water or liquid chemistry back into the gas or vapor phase. The temperature range for evaporation may be between about −20° C. or less to about 120° C. or more while pressure can range from about 1 mtorr or less to about 760 torr or more. This phase transition may dislodge particulate or molecular contaminants from the wafer or critical surface and entrain them in the fluid stream thereby removing them. Reduction of pressure and/or simultaneous increase in temperature is continued for a period of time ranging from about 1 second or less to about 300 seconds or more. In effect, the water or low vapor pressure chemistry may serve as an energy conduit for vacuum force and/or heat addition, where rapid evaporation extricates particle and molecular contamination. Rapid boiling can lift particles from the surface. Repeat of the vapor phase delivery-condensation-evaporation process can be carried out multiple times in a cyclic fashion in order to ensure effective removal of contaminant particles and molecular contamination from wafers and critical surfaces. In a subsequent step, the wafer or critical surface may be held at an elevated temperature in the range of about 30° C. or less to about 120° C. or more to ensure complete dryness prior to removal from the chamber.

In some embodiments, the method may include the presence of a purge gas, a carrier gas and/or chemically reactive gases to assist in particulate or molecular contaminant removal. In this instance, the carrier gas may be introduced in combination with or concurrent to the steam or vapor chemistries and contribute to the rapid condensation step. Subsequently, this gas may promote the entrainment and removal of particle and molecular contaminants during the evaporation step. The carrier gas can include hydrogen, oxygen, nitrogen, helium, argon, ozone, carbon dioxide, carbon monoxide, air, and mixtures thereof. The purge gas can be employed, e.g., concurrent with or after introduction of the steam or vapor chemistries.

With regard to chemistries that may be utilized by the cleaning method, ultra-high purity steam and mixtures of ultra-purity steam are preferred in certain embodiments. Low vapor pressures chemistries may be defined as mixtures of high purity steam together with a one or more chemical reagents, for example, methanol, ethanol, isopropanol or other organic molecules with alcohol (ROH) functional groups, ammonia (NH₃), primary amines (RNH₂), secondary amines (R₂NH) or tertiary amines (R₃N), aqueous organic, for example acetic acid (CH₃COOH) or inorganic acids (for example HX, where X═F, Cl, Br, or I), chloroform, methylene chloride, hexane, toluene, diethyl ether, tetrahydrofuran, acetone, methylethylketone, and other such organic solvents. Mixtures may be in the range of about 0.1% to about 99% water by volume. In a further embodiment, these reagent chemistries may be used in pure form of at or near 100%.

In some embodiments, a particle or molecular contaminant concentrator may be incorporated into or near to the critical surface. This concentrator may be defined as a small area which attracts, adsorbs or has a strong affinity for contaminant particles and molecular impurities. The concentrator may include a highly adsorbent material or coating specifically tailored for particle and/or molecular contaminant adsorption. Examples include thin films of hydrophobic or hydrophilic adsorbents, high surface area porous adsorbents, or thin film adhesives specifically modified for nanoparticle adsorption. The contaminant concentrator may be designed specifically for particle contaminants or molecular impurities or both. In such an embodiment, complete entrainment of the particle contaminant or molecular impurity into the water vapor or gaseous stream is not necessary in that a significant portion of the contaminants may be trapped in a designated area. Consequently it is only necessary for the water vapor condensation/evaporation cycle to impart sufficient force or chemical affinity to dislodge particles and molecular contaminants from critical surfaces such that they may be captured by the concentrator. It is not necessary for the water vapor or gaseous chemistry stream to completely remove particles or molecular contaminants from the environment surrounding the critical surface but instead to act as a carrier to the concentrator. This designated concentrator area may be periodically cleaned or replaced at a later time for instance during routine equipment maintenance.

In some aspects, an apparatus for performing a method of a preferred embodiment includes, for example, a closed chamber designed to contain a semiconductor wafer, semiconductor film, or component including at least one critical surface. In some embodiments, the apparatus further includes, for example, at least one inlet port and at least one outlet port to allow the introduction or removal of at least one of water vapor, low vapor pressure chemistry, or carrier gas. In some embodiments, the apparatus further includes, for example, at least one vacuum pump and pressure controller configured to control chamber pressure. In some embodiments, the apparatus further includes, for example, at least one heater or temperature controller configured to control at least of one of the chamber walls' water vapor, low vapor pressure chemistry, or the carrier gas. In some embodiments, the apparatus further includes, for example, at least one heater or temperature controller configured to control the at least one critical surface, water vapor, low vapor pressure chemistry or the carrier gas. In some embodiments the apparatus may contain an area which concentrates contaminants for subsequent removal. This concentrator area may be adjacent to or in the vicinity of the wafer or the at least one critical surface. The concentrator area may be comprised of an adsorbent tailored for nanoparticle and/or molecular contaminant adsorption. In some embodiments, the apparatus includes, for example, a vaporizer device for water vapor or other low vapor pressure chemistries. In some embodiments, the apparatus is configured to deliver water vapor or other low vapor chemistries to the sub-atmospheric chamber at a controlled rate of about 18 micrograms or less to about 3 kilograms or more per minute.

### EXAMPLES

### Cleaning in EUV Lithography

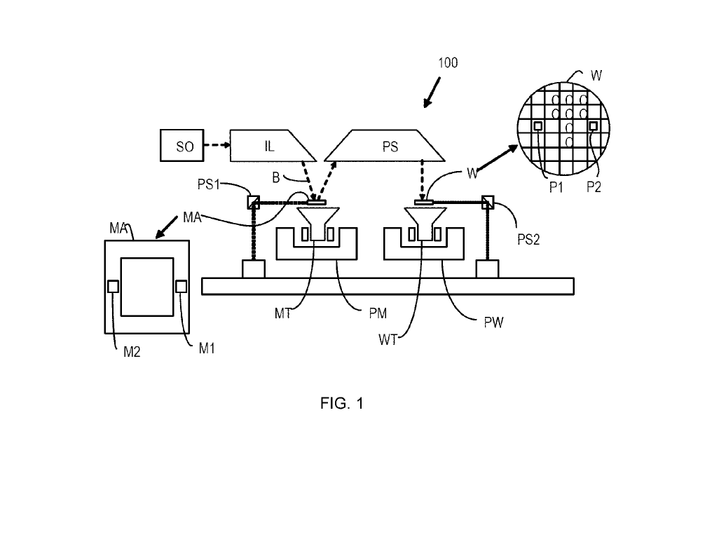

FIG. 1 schematically depicts a lithographic apparatus 100 including a source collector module SO according to one embodiment of the invention. The apparatus comprises an illumination system (illuminator) IL configured to condition a radiation beam B (e.g. EUV radiation); a support structure (e.g. a mask table) MT constructed to support a patterning device (e.g. a mask or a reticle) MA and connected to a first positioner PM configured to accurately position the patterning device; a substrate table (e.g. a wafer table) WT constructed to hold a substrate (e.g. a resist-coated wafer) W and connected to a second positioner PW configured to accurately position the substrate; and a projection system (e.g. a reflective projection system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic, or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic, or other clamping techniques to hold the patterning device. The support structure may be a frame or a table, for example, which may be fixed or movable as required. The support structure may ensure that the patterning device is at a desired position, for example with respect to the projection system.

The term “patterning device” as used herein is a broad term, and is to be given its ordinary and customary meaning to a person of ordinary skill in the art (and is not to be limited to a special or customized meaning), and refers without limitation to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic, or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As depicted in FIG. 1, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream, or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma (DPP) EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus can be used in at least one of the following three modes:

1. In step mode, the support structure (e.g., mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.
2. In scan mode, the support structure (e.g., mask table) MT and the substrate table WT are scanned synchronously while a pattern imparted to the radiation beam is projected onto a target portion C (i.e. a single dynamic exposure). The velocity and direction of the substrate table WT relative to the support structure (e.g., mask table) MT may be determined by the (de-)magnification and image reversal characteristics of the projection system PS.
3. In another mode, the support structure (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

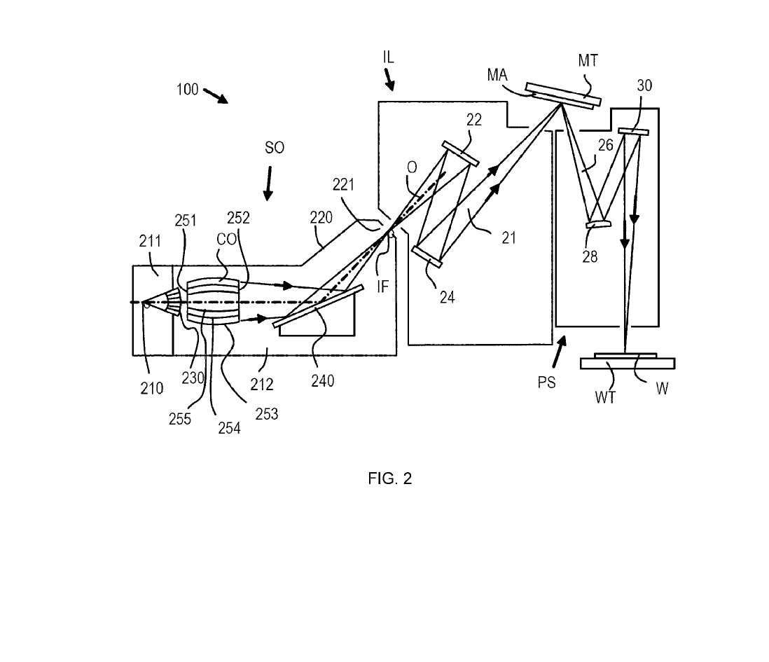

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge yielding an at least partially ionized plasma. Partial pressures of, for example, 10 Pa of Xe, Li, Sn vapor, or any other suitable gas or vapor may be employed for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 211 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

More elements than shown may generally be present in illumination optics unit IL and projection system PS. The grating spectral filter 240 may optionally be present, depending upon the type of lithographic apparatus. Further, there may be more mirrors present than those shown in the Figures, for example there may be 1-6 additional reflective elements present in the projection system PS than shown in FIG. 2.

Collector optic CO, as illustrated in FIG. 2, is depicted as a nested collector with grazing incidence reflectors 253, 254 and 255, just as an example of a collector (or collector mirror). The grazing incidence reflectors 253, 254, and 255 are disposed axially symmetric around an optical axis O and a collector optic CO of this type is preferably used in combination with a discharge produced plasma source, often called a DPP source.

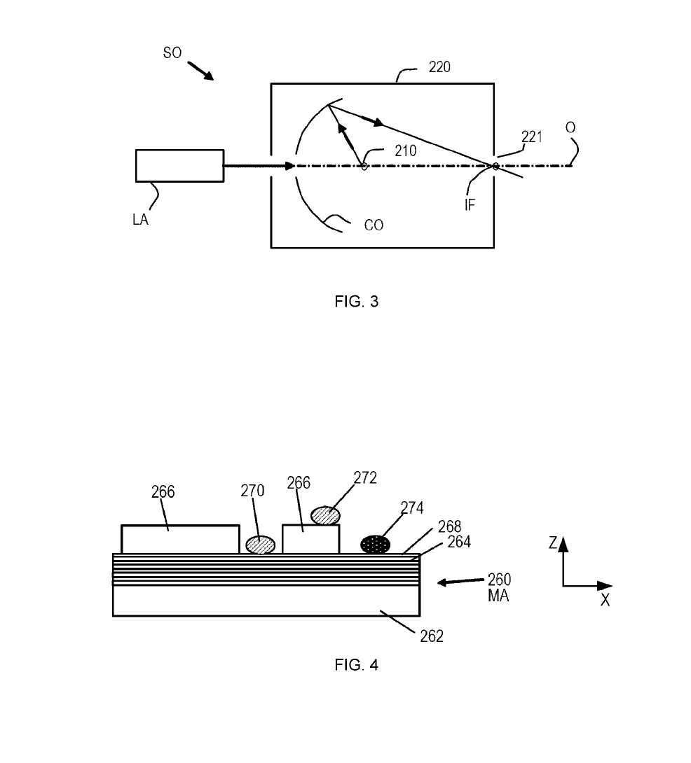

Alternatively, the source collector module SO may be part of an LPP radiation system as shown in FIG. 3. A laser LA is arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector optic CO and focused onto the opening 221 in the enclosing structure 220.

The following description presents apparatus and methods that allow the cleaning of particles on the object. The object to be cleaned can be, for example, a lithographic patterning device for generating a circuit pattern to be formed on an individual layer in an integrated circuit. Example patterning devices include a mask, a reticle, or a dynamic patterning device. The reticles can also be for use within any lithography process, such as EUV lithography and imprint lithography for example.

FIG. 4 illustrates a typical EUV reticle 260 in cross section, which may be the patterning device MA in any of the lithographic apparatuses of FIG. 1, FIG. 2, and FIG. 3. Reticle 260 comprises a substrate 262, multilayer coating 264, and pattern layer 266.

In one example, the reticle 260 can be a EUV reticle including a substrate 262 formed from quartz or another low thermal expansion material, and a reflective multilayer coating 264 including alternate molybdenum and silicon layers. The multilayer coating 264 may for example include several tens of layers and can in one example have a thickness of about 200 nm. The pattern layer 266 defines a pattern for the reticle 260. In the case of an EUV reticle the pattern layer 266 is an absorber layer, while the multilayer 264 is reflective. A capping layer 268 can also be provided at the top surface of the multilayer, being formed for example from ruthenium or silicon.

The pattern layer 266 in an EUV reticle can for example be formed from tantalum nitride (TaN). There may be a surface layer of TaNO. The height of the absorber may in one example be approximately 70 nm, and it can have a width of approximately 100 nm (which is approximately four times the critical dimension (CD) of the lithography system, the scaling being due to the demagnification factor between wafer and reticle).

The diagram also shows contaminant particles 270, 272 and 274. These are not part of the reticle 260 but may be adsorbed or deposited on the reticle 260 in some situations. Because a lithography apparatus is complicated and utilizes many different materials, any type of particle can in principle be deposited on the reticle 260. The particles can be of any shape or size and could be deposited on the conductive coating 264 or the pattern layer 266. Example types of particle that might be deposited include organic particles, metal particles and metal oxide particles.

The ability to clean a reticle reliably, without unduly shortening its useful life, becomes important for the commercial application of EUV lithography. The ability to clean delicate articles can be important in other applications also, and the following description is not limited to cleaning of reticles for EUV lithography.

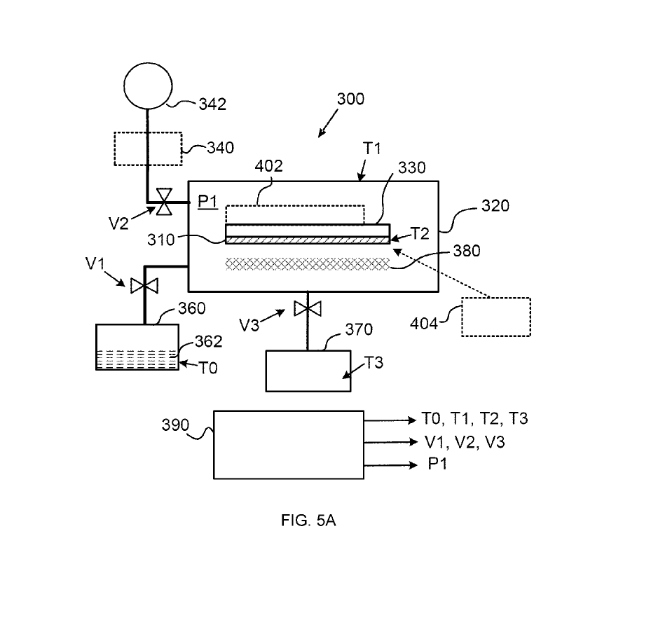

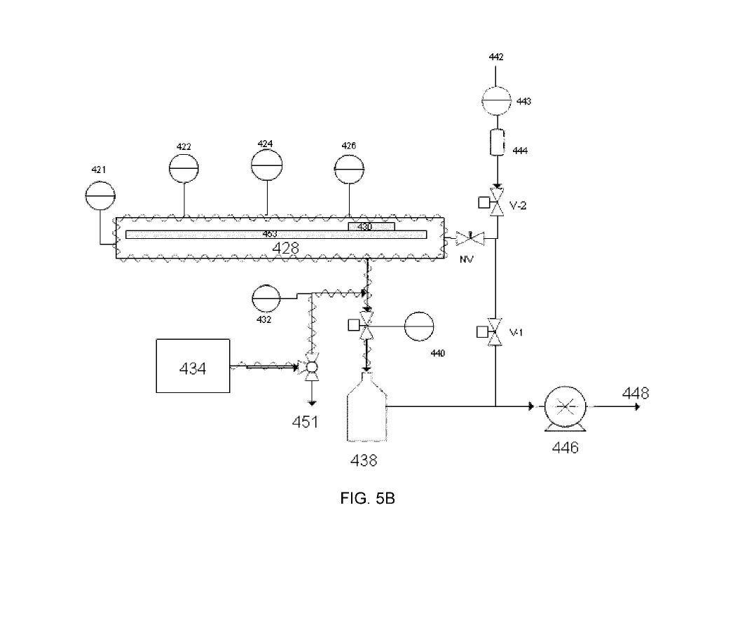

FIG. 5A illustrates an exemplary apparatus 300 for cleaning an article 310 according to a preferred embodiment. Article 310 may be subject to particle contamination. Article 310 may for example be a EUV reticle 260 as shown in FIG. 4. The apparatus 300 includes a cleaning chamber 320, a pressure regulator 340 with a vacuum pump 342, a vapor source 360, a condensing chamber 370 and a controller 390.

Cleaning chamber 320 is configured to contain article 310 for the purpose of cleaning article 310. In one embodiment, cleaning chamber 320 has an article holder 330 for holding article 310 in cleaning chamber 320. The article 310 may operate in the cleaning chamber 320 at a temperature of T2. The temperature of article 310 is controllable by controller 390.

Vacuum pump 342 is linked to cleaning chamber 320 via a valve V2 and via pressure regulator 340. Pressure regulator 340 and valve V2 are controllable by controller 390. Pressure regulator 340 can maintain the pressure P1 of cleaning chamber 320 at a desired value. In particular, pressure regulator 340 is operable with pump 342 to evacuate cleaning chamber 320 so as to keep cleaning chamber 320 in a low pressure or vacuum environment. Pressure regulator 340 can be controlled electronically to change a pressure set point. As such, the operating pressures of pressure regulator 340 can be set and varied from time to time, according to the requirements of a specific operating method. The provision of a pressure regulator separate from vacuum pump 320 is optional. The function of pressure regulation may be replaced for example by appropriate design and control of the vacuum pump, conduits, and other components. It is a matter of design choice and experimentation, what degree of regulation is required in practice.

Vapor source 360 is configured to provide a vapor to cleaning chamber 320 via a valve V1. In this embodiment vapor source 360 comprises a reservoir of liquid having a free surface 362. The atmosphere above liquid surface 362 can be connected to the atmosphere within cleaning chamber 320 via valve V1. Valve V1 and the temperature T0 of vapor source 360 are controllable by controller 390. Vapor source 360 is able to provide vapor of a liquid like pure water into chamber 320 without using a carrier gas to transport the vapor. Other liquids may be used if desired, such as isopropanol or (at higher pressures) CO₂. It is understood that vapor source 360 may use other liquids which may lower the adhesion force between particles and a surface of article 310 and lead to higher drag forces to remove particles from the surface of article 310. The temperatures of the walls and tubing in vapor source 360 are controlled to the same temperature as the liquid.

In a modified embodiment, vapor source 360 includes two or more reservoirs holding different liquids, so that more than one vapor can be generated. The different vapors can be delivered simultaneously (e.g., as a mixture) or sequentially during the condensation phase. The pressure in the cleaning chamber in that case should be below the vapor pressure of both/all liquids, at the temperature of their respective reservoirs.

Condensing chamber 370 is configured to condense liquid vapor released from cleaning chamber 320, when the two chambers are connected by opening a valve V3. In one embodiment, condensing chamber 370 may operate at a temperature T3. Valve V3 and the temperature T3 of condensing chamber 370 are controllable by controller 390.

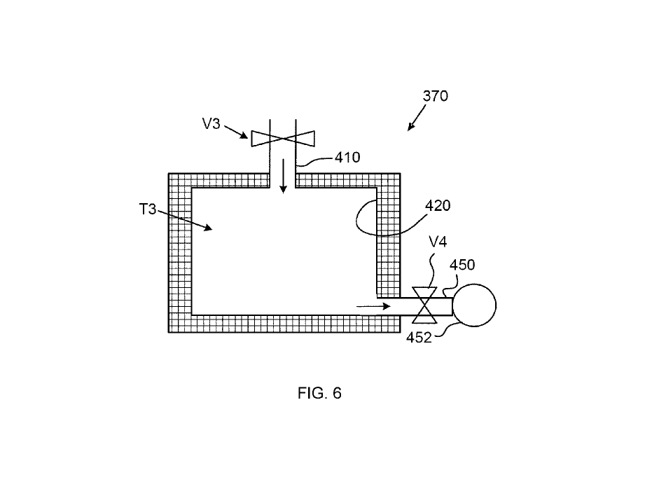

FIG. 6 illustrates in more detail an exemplary condensing chamber 370 for use in the apparatus of FIG. 5A. Condensing chamber 370 has an inner chamber wall 420, an input channel 410 with a valve V3, and a drain 450 with a valve V4. A pump 452 is provided for evacuating chamber 370. Chamber wall 420 may have porous absorbers for condensing liquid vapor released from cleaning chamber 320. Controller 390 can keep the temperature T3 of inner chamber wall 420 at a value, which in use is much lower than the temperature T1 of cleaning chamber 320. Examples of temperatures will be given below. Condensing chamber wall 420 may be water cooled using a water jacket. Other coolants or additives may be used to prevent freezing in the cooling system of the water jacket. In another embodiment, the condensing chamber wall 420 is cooled by liquid nitrogen. In such case, the vapor freezes to the wall 420. To drain the condensing chamber 370 from excess frozen liquid the wall 420 may be heated up, and a vacuum pump may be employed to assist in removal of noncondensable gases and other vapors.

Returning to FIG. 5A, controller 390 may include one or more temperature sensors, pressure sensors, and sequencing/processing functions. Controller 390 is configured to control the valves V1, V2 and V3, the temperatures T0, T1, T2, and T3 of vapor source 360, cleaning chamber 320, article 310 in cleaning chamber 320 and condensing chamber 370, and the pressure P1 of cleaning chamber 320, respectively. Such a control by controller 390 may be made via wired or wireless communication. Controller 390 can maintain the pressure P1 of cleaning chamber 320 at a desired value by coordinating the temperature T0 in vapor source 360 with pressure regulator 340. Controller 390 in use can control the temperature T2 of article 310 at a value which is below the dew point of the liquid vapor in cleaning chamber 329 at the pressure P1, so that the liquid vapor in cleaning chamber 320 can condense and form a liquid film on at least one surface of article 310, as further described below. When steam is employed as the vapor, the vapor source 360 can be an apparatus as described in PCT Publ. No. WO 2007/058698-A1, the contents of which are hereby incorporated by reference in their entirety, which provides for delivery of the steam at a controlled pressure and temperature.

In the present embodiment, the apparatus 300 further includes an electrostatic trap 380, as shown in FIG. 5A. Electrostatic trap 380 may be placed close to article 310 so as to capture the particles contained in the released liquid film. Electrostatic trap 380 may have a replaceable, open grid structure such that the flow of liquid vapor is not obstructed. The grid or other structure 380 may be cleaned off-line. To prevent liquid vapor interfering with the electrostatic trap 380, the voltage and distance between article 310 and electrostatic trap 380 are set with regard to the vapor pressure so that there is no breakdown for the electric field between article 310 and electrostatic trap 380. The threshold for breakdown is defined by the so-called Paschen curve, as described in a paper “Low pressure Breakdown in Water Vapour” by D Marić et al, 29^{th} ICPIG, July 2009, Cancún, Mexico.

The apparatus 300 optionally includes a vibration module 402, as shown in broken lines in FIG. 5A. Vibration module 402 may include one or more of piezo-actuators or surface acoustic wave devices. Vibration module 402 may be positioned close to the article holder 330. Vibration module 402 is operable to vibrate article 310 gently so as to help dislodging particles and releasing the liquid film from the surface of article 310 without damaging article 310. Compared with vibration-based methods without the evaporation of a liquid layer, the vibrations used can be much gentler.

The apparatus 300 further optionally includes a laser module 404, as shown in FIG. 5A. Laser module 404 is operable to apply heat to help releasing a liquid film from the surface of article 310. For that purpose, laser module 404 may include an excimer laser or infrared radiation source.

In an alternative embodiment, an apparatus is provided as in FIG. 5B. The apparatus includes Chamber Heater Temperature Controller 421, Lid Heater Temperature Controller 422, Baratron 424, Peltier Resistance Temperature Detector 426, Cleaning Chamber 428, Peltier Element 430, Inlet Heater Temperature Controller 432, Steamer 434, Vent 436, Cold Trap 438, Outlet Heater Temperature Controller 440, Gas Inlet 442, Mass Flow Controller 443, 0.003 Micron Gas Filter 444, Valve V-2, Valve V-1, Needle Valve NV, Pump 446, and Vent 448 and Vent 451. The apparatus is configured to hold a wafer 453. The path through Valve V-2 allows a purge gas to be used during the evaporation step. The Pump 446 is configured to remove any material that is not captured by the media in the Cold Trap 438, including particles or any gases that are not moisture. This configuration also allows for the removal of any carrier gas used during the deposition or evaporation steps. In alternative embodiments, a pump can be employed without a cold trap. The path through Needle Valve NV and Valve V-1 allows for the pressure in the chamber to be selected during the deposition step.

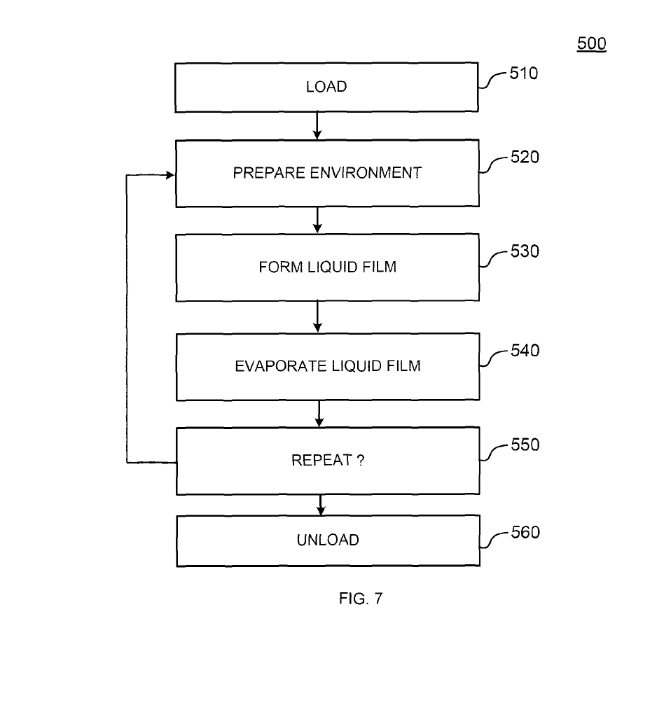

FIG. 7 illustrates an exemplary method 500 for cleaning an article 310 using the apparatus 300 as shown in FIG. 5 according to a preferred embodiment. The method 500 includes the following steps. All these steps are performed under control of signals from controller 390. Some or all steps can be manually controlled if preferred.

At step 510, article 310 is placed in cleaning chamber 320. At step 520 valves V1 and V3 are closed by controller 390. Valve V2 is open and the pump 342 operates for a period of time to evacuate cleaning chamber 320 to a low pressure, effectively a vacuum. Condensing chamber 370 is also drained and evacuated. Temperatures T0, T1, T2 and T3 are controlled to desired values such that T3<T2<T0<T1. Examples of temperature values will be given later.

At step 530, cleaning chamber 320 is connected to a vapor source 360 by opening valve V1. Because the pressure P1 in the evacuated chamber 320 is lower than the vapor pressure Pₛₐₜ (T0) of the chosen liquid at temperature T0, the liquid at temperature T0 partially evaporates and the vapor is re-released from vapor source 360 and distributed throughout cleaning chamber 320. The vapor source can include gaseous sources of water vapor and/or liquid sources of water vapor.

During step 530, the pressure of cleaning chamber 320 may be controlled actively through the pressure regulator 340, passively through the condensing chamber 370, or by the use of a carrier gas (e.g., N₂, argon, or the like). In one embodiment, valve V1 is open and pressure regulator 340 and pump 342 operates to remove excess vapor from the chamber, to maintain the pressure P1 of cleaning chamber 320 at a predetermined level. In another embodiment, controlling the pressure of cleaning chamber 320 is passive through the condensing chamber 370. When the supply of vapor source 360 stops and valve V1 closes, the pressure of cleaning chamber 320 drops rapidly and substantially corresponds to the pressure of condensing chamber 370.

The controlled temperature T2 of article 310 is lower than the dew point of the vapor in cleaning chamber 320 at the pressure P1. As a result, a liquid film condenses and forms over article 310. The condensation of the liquid vapor is normally initiated at crevices and holes which exist in article 310 itself and between contaminant particles and article 310. In addition, water vapor may condense on the particle surface, including spaces between the particle and the surface. As a result of condensation energy being released, the formed liquid film may lower the adhesion forces or dislodge the particles from article 310 during the condensation, which makes the removal of the particles over article 310 easier at a later step. The thickness of the liquid film can be controlled by controlling the temperature T0 of vapor source and the temperature T2 of article 310 and the time of condensation. In one example, the thickness of liquid film is about 1 μm.

The temperature T1 of the walls of cleaning chamber 320 can be controlled in relation to temperatures T0 and T2 to achieve different effects as desired. In one embodiment of the cleaning method for article 310, temperature T1 is maintained above the temperature of the liquid vapor so that the liquid vapor does not form a liquid film over the walls of cleaning chamber 320. In other embodiments, the walls of cleaning chamber 320 are controlled to a temperature below the temperature of the liquid vapor so that the liquid vapor can form a liquid film over the walls of cleaning chamber 320. Forming a liquid film over the walls of cleaning chamber 320 can be used in different ways. In one embodiment, the walls of cleaning chamber 320 are also cleaned of particles, by rapid evaporation of the liquid film (this can be done while the chamber 320 is empty of any article 310, if preferred). Alternatively, or at other times, the temperature T1 can be controlled so that, when article 310 is cleaned by evaporation, the liquid film over the walls of cleaning chamber 320 is maintained. This may have the benefit of preventing dislodging particles from the walls of cleaning chamber 320 that may re-contaminate article 310.

At the end of the film forming step 530, valves V1 and V2 are closed when the desired liquid film is formed. Consequently, cleaning chamber 320 is isolated from vapor source 360 and may also be isolated from pressure regulator 340.

At step 540, the liquid film formed over article 310 is caused to evaporate quickly by opening valve V3 so that the vapor atmosphere in cleaning chamber 320 is exposed to condensing chamber 370. The temperature T3 of surfaces inside condensing chamber 370 is substantially lower than the temperatures T1, T2, inside cleaning chamber 320. Therefore the pressure P1 due to vapor in chamber 320 is greater than the vapor pressure Psat (T3) of the chosen liquid in the colder environment of the condensing chamber 370. Since valve V3 is open, the liquid vapor inside cleaning chamber 320 is drawn to the condensing chamber 370 and condenses rapidly therein. Since the condensing of liquid vapor is in a relevantly fast rate, the pressure in the condensing chamber 370 is substantially maintained during the condensing period. Consequently, an evacuation of the chamber takes places, and the condensed liquid film over article 310 can be quickly vaporized due to a nucleate boiling effect. The pressure inside cleaning chamber drops rapidly. Where provided, the vibration module 402 and/or laser module 404 can optionally be used to further boost the evaporation of the condensed liquid film and to help dislodging particles from article 310. The pressure can be maintained low by a vacuum pump to remove noncondensable gases and other vapors.

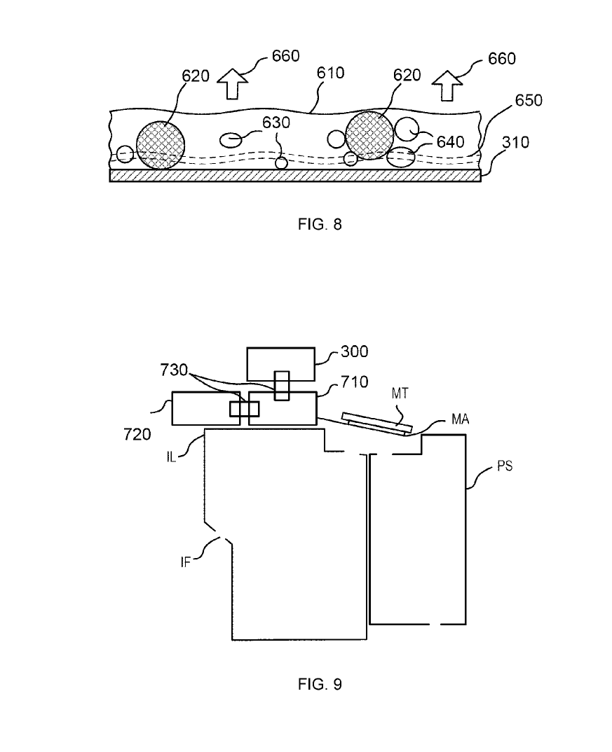

The boiling and cleaning effect of the liquid film can be understood by reference to FIG. 8. As the pressure drops in cleaning chamber 320, small vapor bubbles 630 and 640 are formed over article 310 by homogeneous and/or heterogeneous nucleation. In the latter case, the bubbles 640 are formed around the particles, particularly between the particles and a surface of article 310. The sudden appearance and growth of bubbles creates shear forces 650 inside the liquid film. These shear forces can exert force on the particles such that at least a portion of the particles are released from article 310. There is a net flow of vapor 660 away from article 310, which drags the released particles along in the direction of the condensing chamber 370.

Contaminant particles released by the evaporation may be entrained in the flow of vapor and re-deposited at other locations in the cleaning chamber or condensing chamber. In order to prevent re-deposition on the article 310, and to control where contaminant particles re deposited, electrostatic trap 380 is operated in the vicinity of the article 310. As mentioned already, the trap electrode structure can be made removable for cleaning or renewal.

As mentioned, condensing chamber 370 may have walls 420 with porous absorbers, or may include other surfaces for concentrating contaminants (concentrators). The benefit of using porous absorbers is to increase the effective surface area available for condensing liquid vapor in a relatively small space. The porous absorbers may be made of a metal having a high thermal conductivity, for example copper, or a zeolite adsorbent may be used. Of course, all materials must be chosen for compatibility with the lithographic environment or other environment. After the liquid vapor with the particles enters into condensing chamber 370, condensing chamber 370 with the porous absorbers condenses the liquid vapor with the particles. After a period of operation, controller 390 may open the valve V4 to evacuate the liquid vapor in condensing chamber 370 through drain 450. A vacuum pump may also be used, with our without a purge gas, to assist in evacuating the chamber.

It is understood that steps 520 to 540 may be repeated for one or more times in cleaning article 310 to remove at least a portion of particles from article 310.

At step 550, it is determined whether the cycle of film forming and evaporation should be repeated, or cleaning is complete. This may be based on a simple rule, or on inspection of the article. At step 560 the cleaned article is unloaded from the cleaning chamber (with suitable precautions against recontamination).

To give a numerical example, apparatus 300 can be used to clean an article 310 according to the method 500 as described above by using values in the following table 1.

TABLE 1

| | | | | P1 | T0 | T1 | T2 | T3 | Time |
|---|---|---|---|---|---|---|---|---|---|
| Step | V1 | V2 | V3 | [kPa] | [° C.] | [° C.] | [° C.] | [° C.] | [s] |
| Initialization | X | ◯ | X | <1 | 38 | 40 | 30 | 1 | 10 |
| Condensation | ◯ | ◯ | X | 5.6 | 38 | 40 | 30 | 1 | 2 |
| Stop | X | X | X | 5.6 | 38 | 40 | 30 | 1 | 0 |
| condensation | | | | | | | | | |
| Evaporation | X | X | ◯ | <1 | 38 | 40 | 30 | 1 | 2 |

In Table 1, symbol ‘X’ represents that a valve is closed and symbol ‘O’ represents that a valve is open. It can be seen that temperature of the article T2 is controlled to a value that is certainly lower than temperature T0 of the liquid in vapor source 360, but not by many degrees. This allows the liquid film to form in a controlled manner. Temperature T3 of the condensing chamber 370, on the other hand, is many degrees lower than T1, so as to promote rapid condensation in chamber 370 and consequently rapid evaporation from article 310. The difference between temperatures T0 and T2 may be for example in the range 5 to 15 degrees. The difference between temperatures T2 and T3, on the other hand, may be greater than 20 or 30 degrees. The temperature T1 of the cleaning chamber walls need only be a few degrees higher than T0, to keep the walls dry.

Provided the temperatures are in appropriate relationships to one another, different values can be chose. As an example, the temperature T2 of article 310 may be set equal to an operating temperature of the article, so that delays and stresses caused by thermal cycling are avoided. In the case of a reticle for lithography, for example, a temperature T2 of 22° C. may be suitable.

The apparatus 300 described in the above embodiments of the invention may be used to clean a patterning device in a lithographic apparatus. FIG. 9 illustrates an exemplary application of apparatus 300 to a lithographic apparatus according to a preferred embodiment. Referring also to the lithographic apparatus of FIG. 2, cleaning apparatus 300 may be added as a module and positioned close to support structure MT where the reticle is held for use in the lithographic apparatus. This has the advantage of reducing the time for transferring a reticle from MT stage to cleaning apparatus 300. Apparatus 300 may operate with a reticle transferring module 710 and a reticle inspection module 720. The reticle transferring module 710 is operable to transfer a reticle from the MT stage to a reticle inspection module 720 or to apparatus 300 for cleaning the reticle. Reticle inspection module 720 is operable to inspect whether a reticle is free from contaminant particles. If the reticle is not contaminated with particles, reticle transferring module 710 does not need to transfer the reticle into apparatus 300. Cleaning module 300 and inspection module 720 in some embodiments can be operated to clean reticles without completely removing them from the vacuum environment within the lithographic apparatus as a whole. For this purpose, as such, it can enhance the overall yield of the lithographic apparatus. Reticle transferring module 710, the MT stage, the apparatus 300, and reticle inspection module 720 can be connected through airlocks 730 as appropriate.

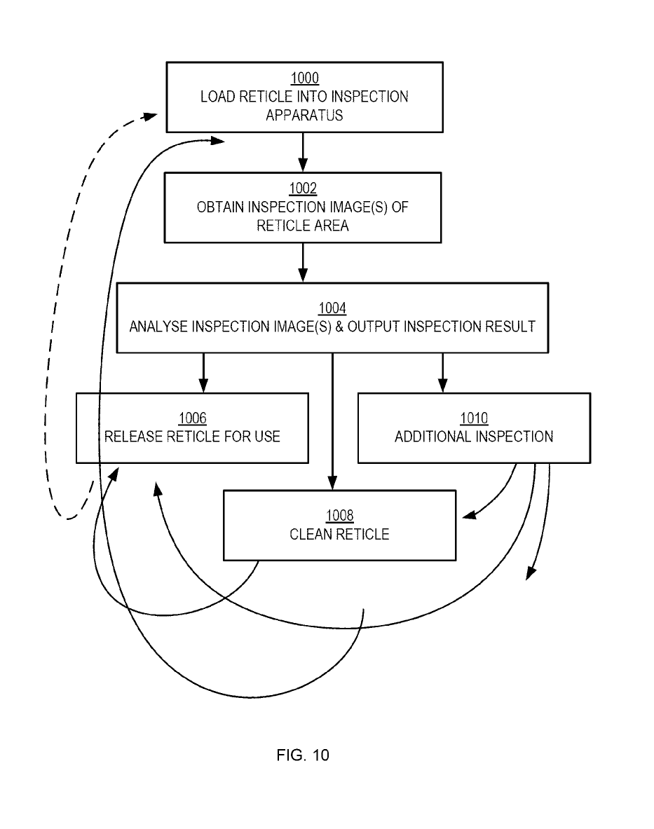

FIG. 10 shows the main process steps of an inspection regime applied to clean reticles in a EUV lithography process, using lithography apparatus such as those described in the above embodiments. The process can be adapted to cleaning of reticles and other patterning devices in other types of lithography, as well as to the cleaning of articles other than lithography patterning devices.

Inspection apparatus, such as reticle inspection module 720 shown in FIG. 9, may be integrated within the reticle housing of the lithographic apparatus, so that the reticle under inspection is mounted on the same support structure (mask table) MT as used during lithographic operations. The mask table may be moved under the inspection apparatus, or equivalently the inspection apparatus is moved to where the reticle is already loaded. Alternatively, reticle 500 may be removed from the immediate vicinity of support structure MT to a separate inspection chamber where the inspection apparatus is located. This latter option avoids crowding the lithographic apparatus with additional equipment, and also permits the use of processes that would not be permitted or would be undesirable to perform within the lithographic apparatus itself. The inspection chamber can be closely coupled to the lithographic apparatus, or quite separate from it, according to preference. Alternative inspection apparatuses can be included in the same or a different chamber, to allow the detection of different types of particles by different processes.

Returning to FIG. 10, a reticle which is an example of a patterning device used in the lithographic apparatus is loaded at step 1000 into the inspection apparatus (or the inspection apparatus is brought to where the reticle is already loaded). Prior to inspection, the reticle may or may not have been used in the lithographic process.

At step 1004, processing unit PU or an external computer analyses the inspection images individually and in combination, to make decisions about further processing of the reticle. If the reticle is found to be clean, it is released at step 1006 for use in the lithographic process. As indicated by the broken arrow, the reticle will return for inspection at a later time, after a period of operation. If the analysis at step 1004 indicates that cleaning of the reticle is required, a cleaning process is initiated at step 1008. After this cleaning process the reticle may be released automatically for re-use, or returned for inspection to confirm success of the cleaning. A third potential outcome of the analysis at step 1004 is to instruct additional inspection. For example, if the reticle is found to be dirty, or the result of inspection is uncertain, it may be taken out of the litho tool and inspected more thoroughly using other tools, e.g., SEM (scanning electron microscopy. This may be to discriminate between different sizes of particles and/or different material types, either for diagnosis of problems in the area of lithographic apparatus or to decide, in fact, the reticle can be released for use.

Embodiments of the methods, apparatus and systems of the present disclosure can in principle be used for cleaning any type of pattern or mask, or indeed any object, not just an EUV lithographic patterning device. The method can also be used to clean smaller particles which are, for example, less than 100 nanometers, less than 50 nanometers or even less than 20 nanometers, and can be used for cleaning all these on substrates such as EUV reticles. The method can also be used to clean particles from a blank substrate or from a patterned substrate.

As mentioned already the cleaning apparatus 300 can be provided as an in-tool device, that is, within a lithographic system, or as a separate apparatus. As a separate apparatus, it can be used for purposes of reticle cleaning (e.g., prior to shipping). As an in-tool device, it can perform a quick cleaning of a reticle prior to using the reticle for a lithographic process.

In a EUV lithographic apparatus, contaminant particles on the back side of a reticle may produce fatal overlay defect if they are trapped between the reticle and the reticle chuck burls. It is understood that the methods and apparatus described above can be applied simultaneously to clean multiple sides of an article, for example a front side and a back side of a reticle for a lithographic apparatus. To clean the front side and the back side of article 310 simultaneously, article 310 can be held from the edges. To ensure efficient cleaning, it can be envisaged that a symmetric configuration of two condensing chambers 370, each with an associated valve V3 and electrostatic trap 380, may be used to collect particles from opposite sides of article 310. Also, since in the above embodiments only water vapor without any carrier gas may be used and no physical forces like shockwaves, plasmas, gas jets etc are used, the techniques described above is less likely damaging an article like a reticle, as compared to the conventional technique of using megasonics to clean a reticle.

Processing of signals from the sensor may be implemented by processing unit PU in hardware, firmware, software, or any combination thereof. Unit PU may be the same as a control unit of the lithographic apparatus, or a separate unit, or a combination of the two.

### Wafer Cleaning

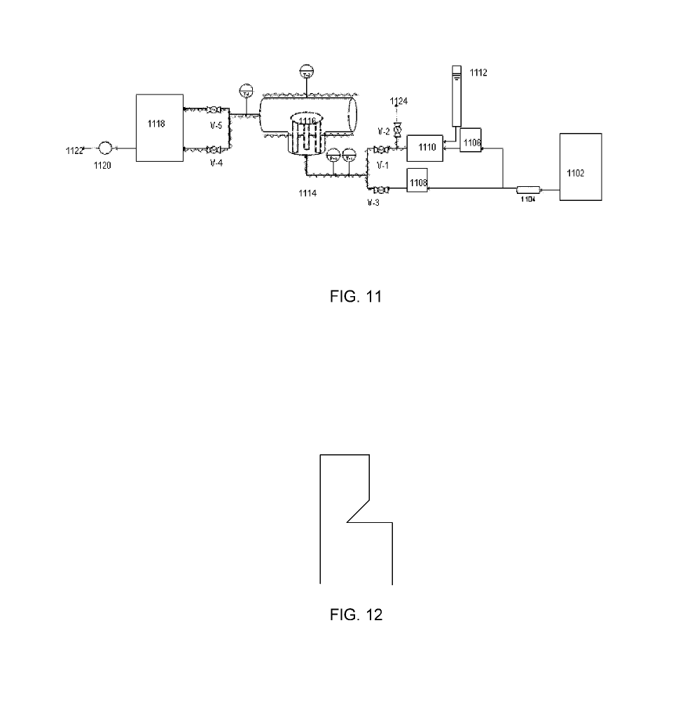

A test manifold as shown in FIG. 11 was constructed. Gas was supplied using an Air Generator 1102 (Zero PAC PFA-1 Air Generator by KIN-TEK™ of La Marque, Tex.). A Gas Filter 1104 (POU-05-SV1 Gas Shield by Mott Corp. of Farmington, Conn.) was placed downstream of the generator for particle removal. Two 200 sccm Unit Mass Flow Controllers (MFCs) 1106, 1108 and a Unit URS-40 Power Supply (not depicted) were used to control the flow rate of the gas flowing through the cleaning chamber; one for the humidified gas stream and one for the dry gas stream. In order to supply a humidified gas stream, a humidification system 1110 (RHS, RainMaker Humidification System by RASIRC of San Diego, Calif.) was used to add purified water vapor to the gas stream. Water was supplied through gravity with a two foot length of ¾″ PFA tubing (Water Fill Leg 1112) positioned above and connected to the RHS. Valves V-1 through V-5 were used to direct the flow of gas to or away from the cleaning chamber 1114. Valve V-2 is directed to a Vent 1124. Valve V-4 was set partially open to hold the cleaning chamber to the desired pressure for water deposition. Once set, Valve V-4 was held at this position during the entire cleaning process. Valve V-5 was opened to vacuum chamber to quickly drop the pressure of the cleaning chamber, evaporating the water on the wafer surface 1116. Four heater tapes were used to heat the sections indicated in FIG. 11 by wavy lines. The heater tape upstream of the cleaning chamber was controlled to 60° C. with thermocouple T-1 and a Watlow EZ-Zone temperature controller (not depicted). The two heater tapes around the cleaning chamber were controlled to 34° C. with thermocouple T-2 and a Xianke temperature controller. The heater tape downstream of the cleaning chamber was controlled to 60° C. with thermocouple T-3 and an Omron E5C2-R40J temperature controller (not depicted). A MKS 621C13TBFHC pressure transducer (P-1) was placed upstream of the cleaning chamber to measure the pressure. Three PTFE posts were used to hold the wafer face down in the chamber. The holding mechanism (notched wafer post) is depicted in FIG. 12. A twelve liter vessel was used as the vacuum chamber 1118. This chamber was held under vacuum pressure with a Varian 949-9411 diaphragm vacuum pump 1120 leading to a Vent 1122.

A cleaning cycle comprising two steps was employed. The first step was water deposition for two minutes and the second step was water evaporation for one minute. An entire cleaning process comprised ten cleaning cycles. For the water deposition step, the parameters were an RHS temperature of 80° C.; a gas flow rate of 100 sccm; and a cleaning chamber pressure of 135 torr. For the water evaporation step, the parameters were a gas flow rate of 100 sccm and a cleaning chamber pressure of <40 torr.

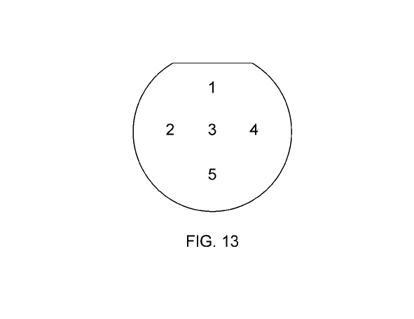

A one inch diameter silicon wafer (ASML of Veldhoven, the Netherlands) was used for testing. Red fluorescent 500 nm polystyrene latex particles were attached to the wafer surface. Before undergoing the cleaning process, the attached particles were examined and photographed using a Zeiss Axioskop 2 Mot Plus florescent microscope using a Zeiss Axiocam MRM camera. The software used to collect the data was Axiovision 4.3. Before examining the wafer surface, five areas were marked on the wafer with a red, fine-point Sharpie, as shown in FIG. 13. These marks were used to ensure that the same areas were being analyzed before and after the cleaning process.

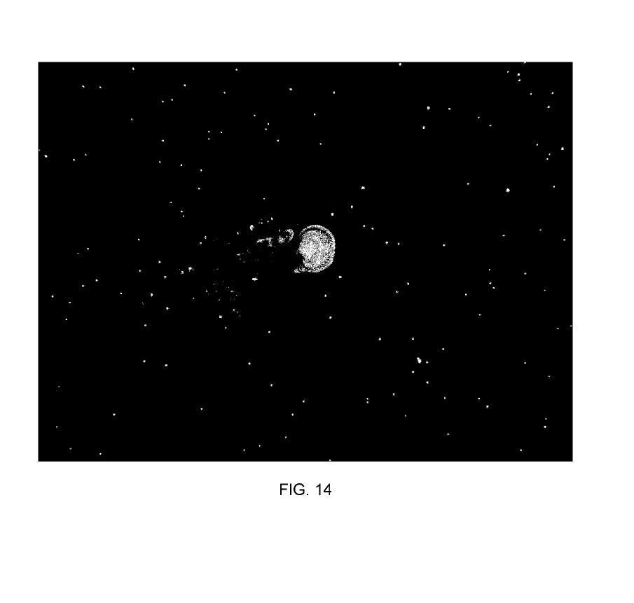

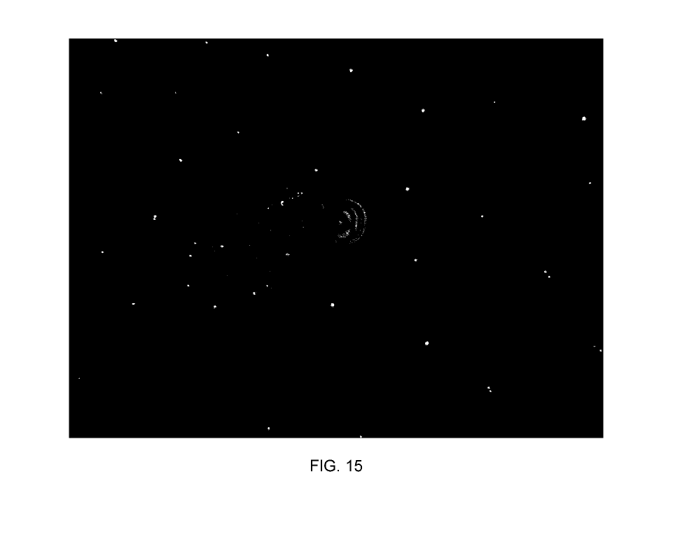

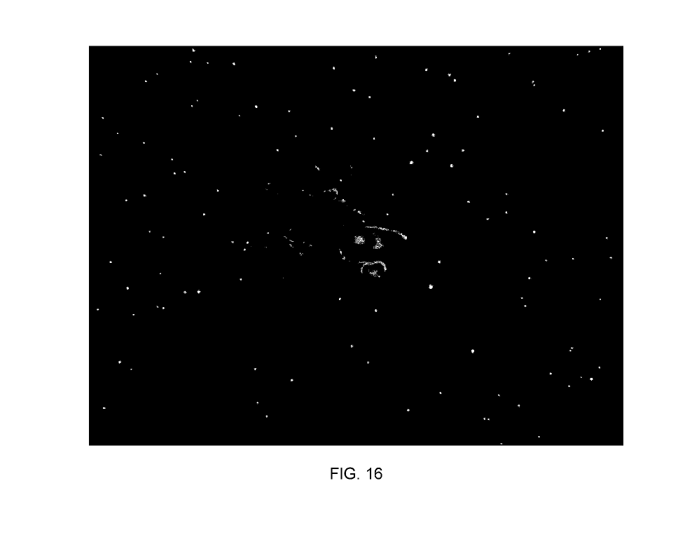

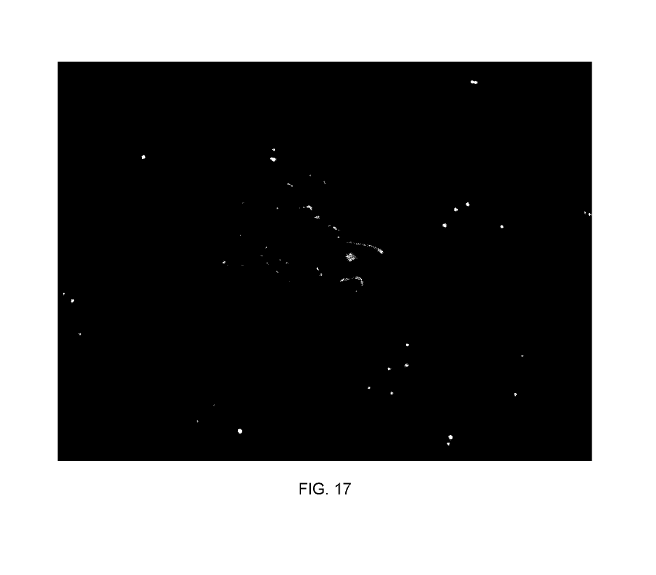

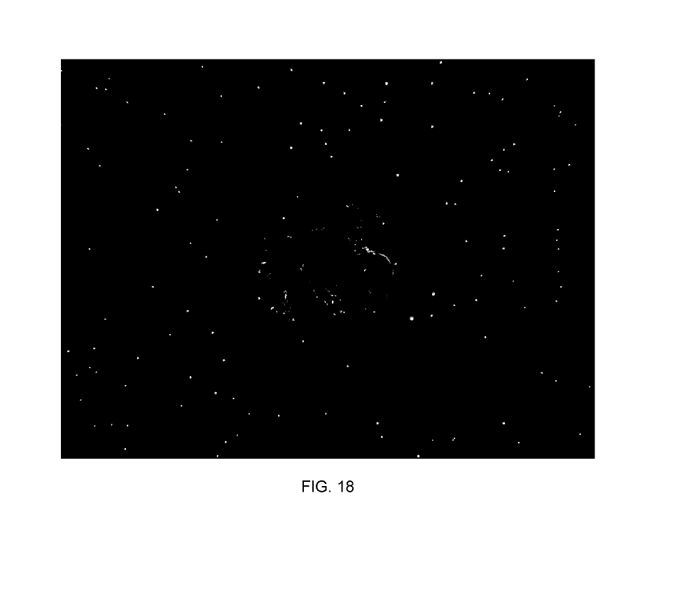

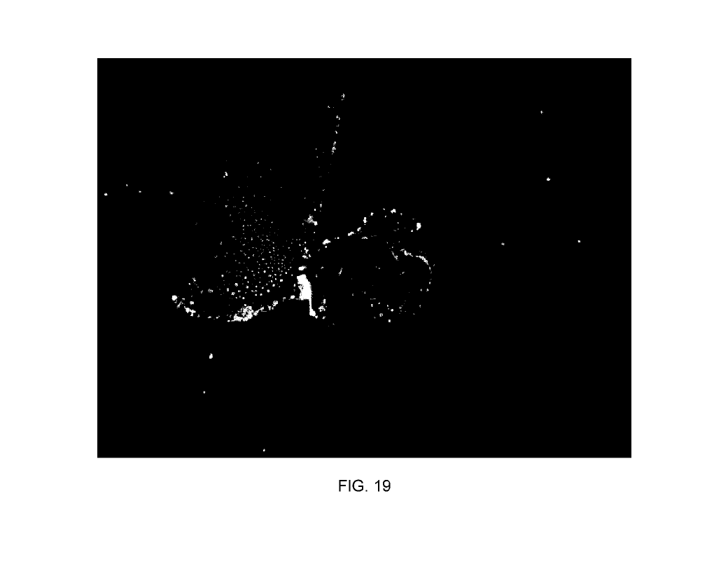

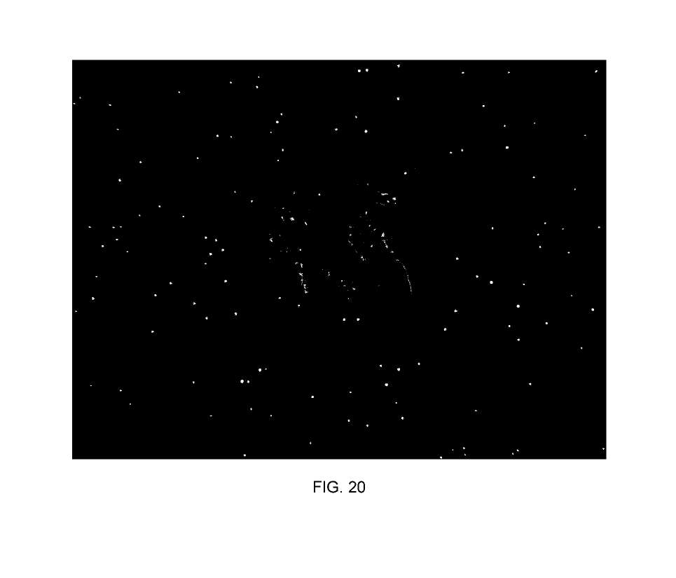

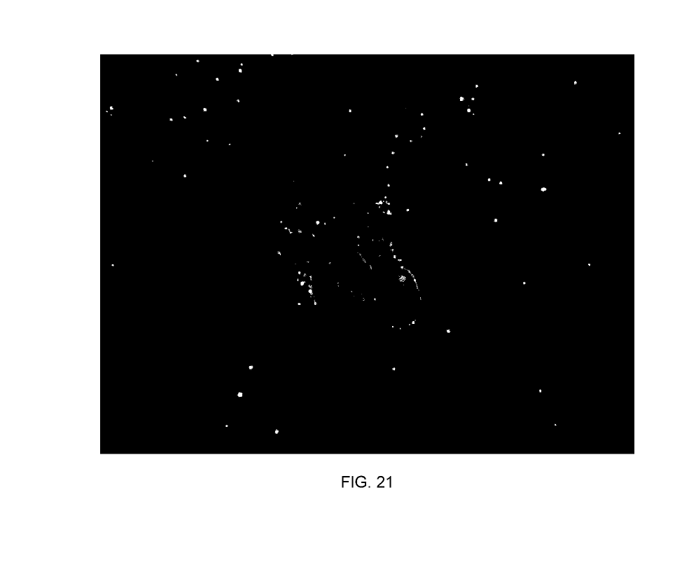

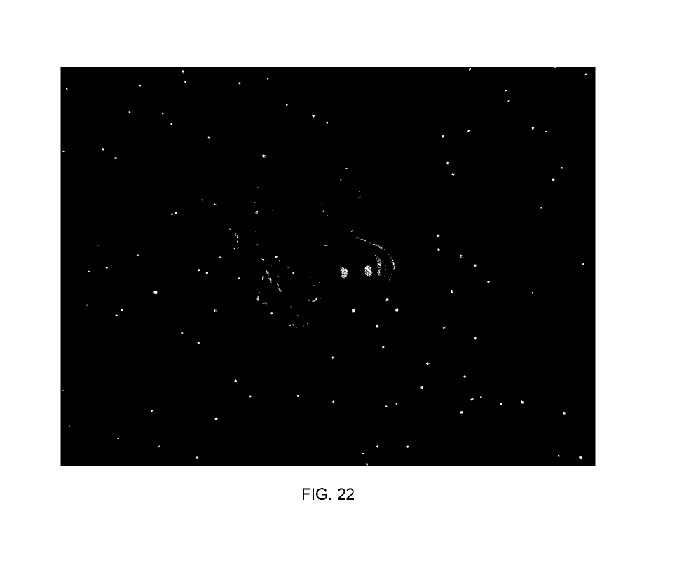

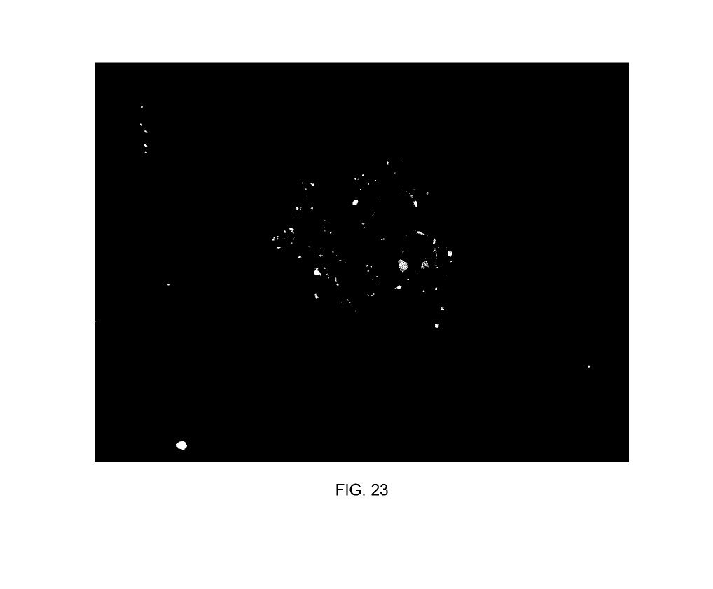

Photographs of the five designated areas of FIG. 13 before and after the cleaning process (FIGS. 14 and 15, Area 1 before and after cleaning, respectively; FIGS. 16 and 17, Area 2 before and after cleaning, respectively; FIGS. 18 and 19, Area 3 before and after cleaning, respectively; FIGS. 20 and 21, Area 4 before and after cleaning, respectively; and FIGS. 22 and 23, Area 5 before and after cleaning, respectively). The photographs taken before and after cleaning showed that the fluorescent particles were removed from or were moved on the wafer's surface. The movement of particles indicates that the particles resettled after leaving the wafer's surface.

It is also noted that the ink marks appeared to collect the fluorescent particles. It was found that the amount of particles in the ink marked areas increased as a result of the cleaning process, as shown in FIG. 21 and FIG. 23. This indicates that areas within the cleaning chamber can be provided that advantageously attract particles so they do not resettle on the wafer surface.

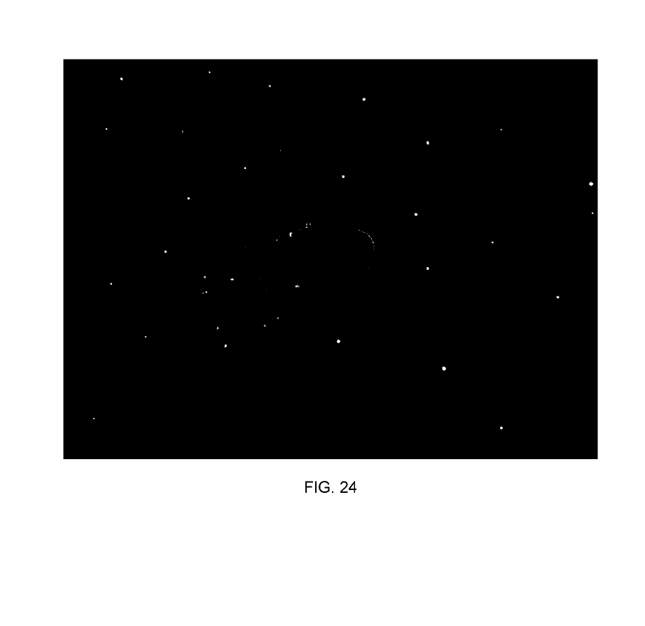

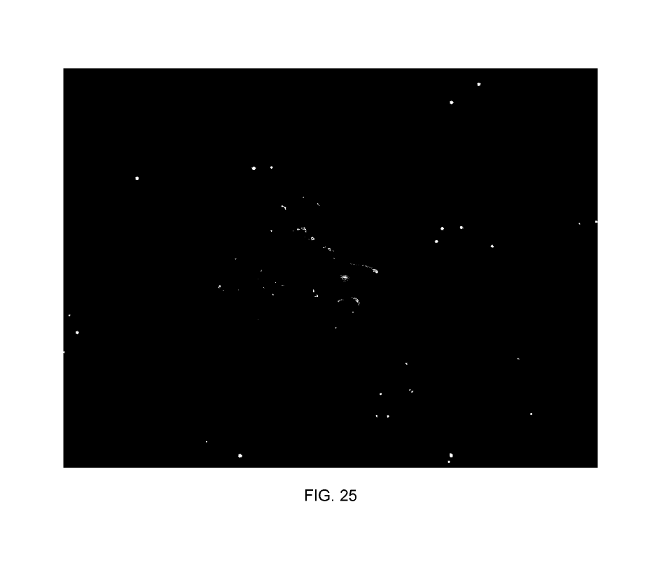

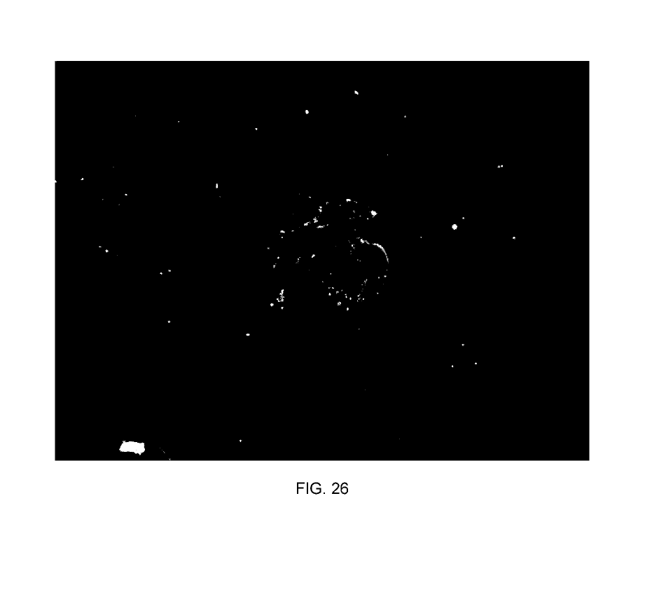

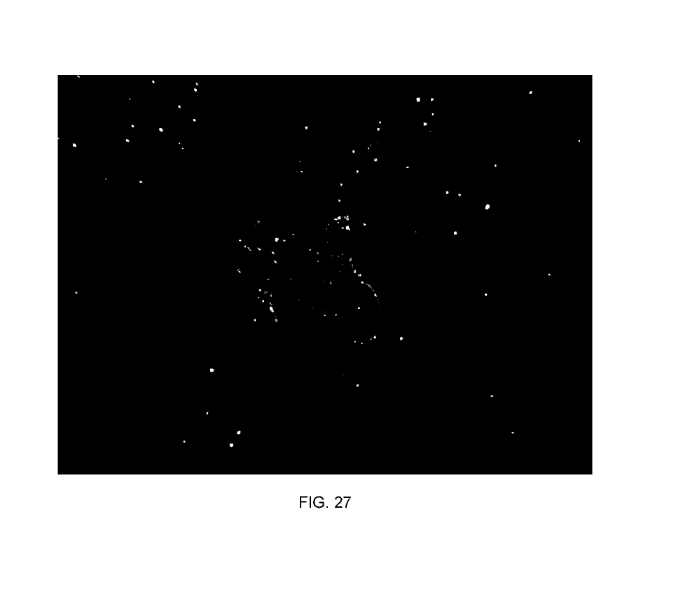

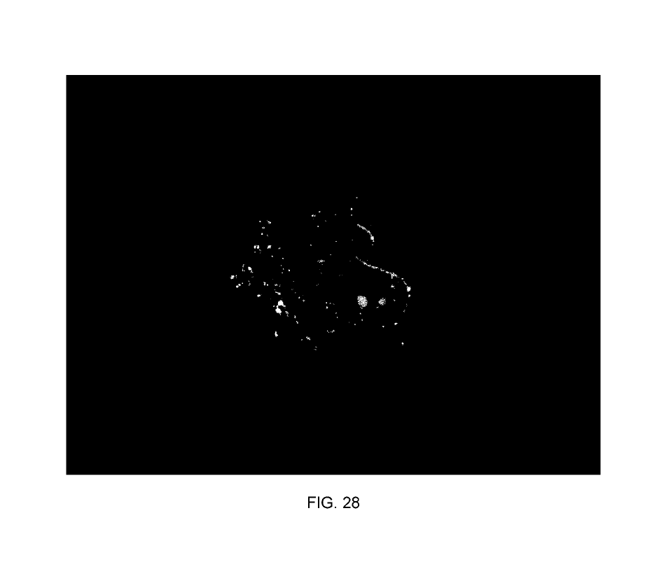

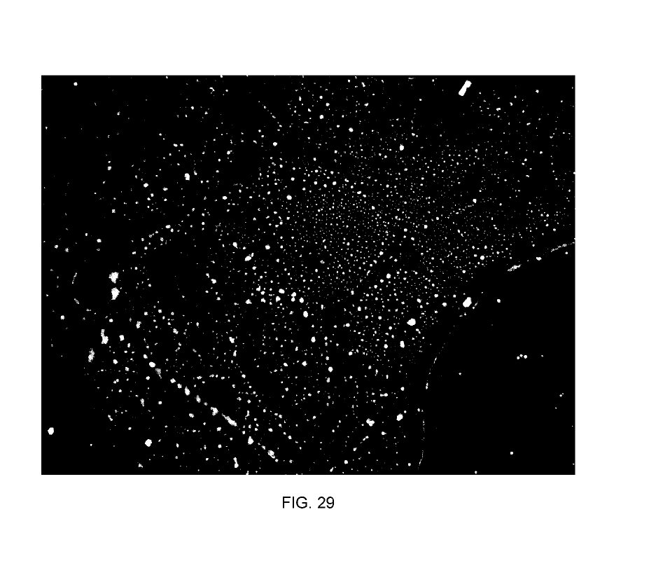

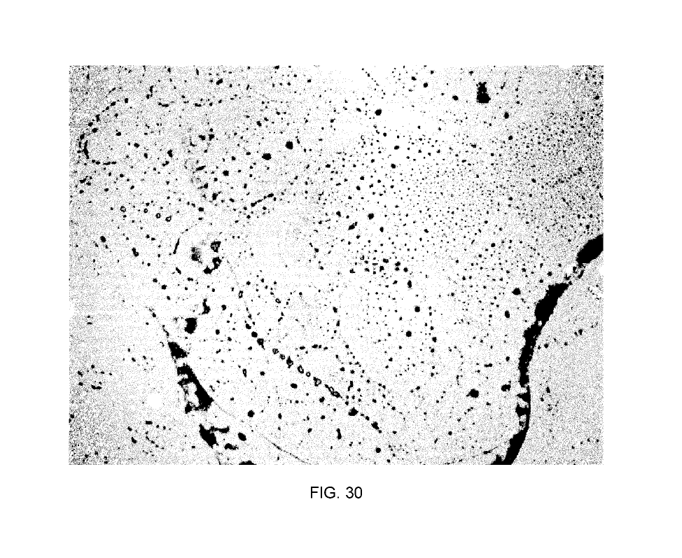

Water droplets were observed on the surface of the wafer when it was removed from the cleaning chamber (see FIG. 29 and FIG. 30). Pools of water forming on the wafer surface can lead to staining. One of these stains is seen in the top left quadrant of FIG. 19. To eliminate the water droplets, the temperature of the cleaning chamber was raised to 45° C. for the next cleaning process. The wafer and all other test parameters remained the same. At the higher temperature, water droplets were not visible on the wafer surface when it was removed from the cleaning chamber. It was found that a number of particles were removed and moved during the cleaning process, as shown in FIG. 24 through FIG. 28. FIG. 16 shows that the water stain from Area 3 was also removed. This disappearance indicates that some stains can be removed by this cleaning process. However, there were still stains in other places on the wafer. FIG. 19 and FIG. 20 show water stains remaining on the wafer's surface. It is not determinable whether these stains developed during the previous cleaning process or during this cleaning process.

The test results indicate that the cleaning process can remove a substantial quantity of particles from a silicon wafer. More complete removal of the particles from the wafer surface may be obtained by adjusting gas flow rates and directions during the water evaporation step. The temperature of the cleaning chamber can be adjusted to ensure that water droplets do not form on the wafer's surface. Lastly, particle traps that emulate the results seen from the ink marks can be employed.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Any reference signs in the claims should not be construed as limiting the scope. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The mere fact that certain measures are recited in mutually different dependent claims does not indicate that a combination of these measures cannot be used to advantage.

Where a range of values is provided, it is understood that the upper and lower limit, and each intervening value between the upper and lower limit of the range is encompassed within the embodiments.

Embodiments of the invention of various component parts of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines or instructions may be described herein as performing certain actions. However, it should be appreciated that such descriptions are merely for convenience and that such actions in fact result from computing devices, processors, controllers, or other devices executing the firmware, software, routines, instructions, etc. A single processor or other unit may fulfill the functions of several items.

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

1-75. (canceled)

76. A method of cleaning an article, comprising:
(a) subjecting a first chamber containing the article having contaminants on a surface of the article to a vapor source while controlling a temperature of the article and a temperature of the vapor source relative to one another such that vapor from the vapor source condenses on the surface to form a liquid film; and
(b) evaporating the liquid film, whereby the evaporating liquid transports at least a portion of the contaminants away from the surface,
wherein the evaporating comprises exposing the first chamber to one or more condensing surfaces having a temperature lower than a temperature of the article, whereby the evaporated liquid condenses on the condensing surfaces.

77. The method according to claim 76, wherein the one or more condensing surfaces is a wall of a second chamber connected to the first chamber via a valve, and wherein the evaporating comprises opening the valve between the first chamber and the second chamber.

78. The method according to claim 76, wherein the surface of the article is held at a temperature of from about −20° C. to about 120° C. during the condensing of the evaporated liquid.

79. The method according to claim 76, wherein the evaporating comprises exposing the first chamber to a lower pressure, whereby the evaporated liquid is removed from the first chamber.

80. The method according to claim 76, wherein the vapor source is a reservoir of a liquid controlled to have a temperature higher than that of the article.

81. The method according to claim 76, further comprising controlling a temperature of the walls of the first chamber to be higher than a temperature of the vapor source.

82. The method according to claim 76, further comprising controlling a pressure of the first chamber by a vacuum pump connected to the first chamber, wherein the vacuum pump is isolated from the first chamber prior to the evaporating.

83. The method according to claim 76, wherein the first chamber further comprises an electrostatic structure for attracting contaminant particles in the evaporated liquid film.

84. The method according to claim 76, wherein the vapor is delivered at a temperature of from about −20° C. to about 120° C.

85. The method according to claim 76, wherein the vapor is delivered at a pressure of from about 0.1 torr to about 2000 torr.

86. The method according to claim 76, wherein the surface of the article is held at a temperature of from about −20° C. to about 120° C. during the evaporating.

87. The method according to claim 76, wherein the vapor comprises high purity steam.

88. The method according to claim 76, wherein the vapor comprises one or more alcohols selected from the group consisting of methanol, ethanol, isopropanol, and organic molecules with one or more alcohol functional groups.

89. The method according to claim 76, wherein the vapor comprises one or more members of the group consisting of ammonia, primary amines, secondary amines, aqueous organic acids, and aqueous inorganic acids.

90. The method according to claim 76, wherein the vapor comprises one or more organic solvents.

91. The method according to claim 76, wherein the vapor comprises one or more organic solvents selected from the group consisting of chloroform, methylene chloride, hexane, toluene, diethylether, tetrahydrofuran, acetone, methylethylketone, acetonitrile, N-methylpyrrolidone, ethyl acetate, butyl acetate, and fluorinated hydrocarbons.

92. The method according to claim 76, further comprising repeating steps (a) and (b) at least one time.

93. The method according to claim 76, further comprising adsorbing nanoparticle or molecular contaminants from the evaporated liquid on a concentrator comprising a highly adsorbent material or coating.

94. A apparatus for cleaning an article, comprising:
a first chamber configured for housing the article having contaminants on a surface of the article;
a vapor source connected to the first chamber via a first valve;
a temperature controller configured to control a temperature of the article and a temperature of the vapor source relative to one another such that vapor from the vapor source condenses on a surface of the article to form a liquid film; and
a second chamber connected with the first chamber via a second valve, and configured to collect vapor evaporated from the article so as to transport contaminants away from the surface of the article.

95. The apparatus according to claim 94, wherein the temperature controller is further configured to control a temperature of the walls of the first chamber relative to the vapor source so as to prevent condensation of the vapor on the walls of the first chamber.
